(19) United States
(12) Patent Application Publication
(10) Pub. No.: US 2019/0331098 A1
(43) Pub. Date: Oct. 31, 2019

(54) HEAT STORAGE DEVICES FOR SOLAR STEAM GENERATION, INCLUDING RECIRCULATION AND DESALINATION, AND ASSOCIATED SYSTEMS AND METHODS

(71) Applicant: GlassPoint Solar, Inc., Fremont, CA (US)

(72) Inventors: Peter Emery von Behrens, Oakland, CA (US); Justin Raade, Fremont, CA (US); Hayden Graham Burvill, San Carlos, CA (US); Christopher Jon Spindt, Fremont, CA (US); John Setel O'Donnell, Oakland, CA (US)

(21) Appl. No.: 16/206,838

(22) Filed: Nov. 30, 2018

Related U.S. Application Data
(60) Provisional application No. 62/594,002, filed on Dec. 3, 2017.
(60) Provisional application No. 62/643,112, filed on Mar. 14, 2018.

(51) Int. Cl. F03G 6/06; F28D 20/00

(52) U.S. Cl. CPC F03G 6/065; F28D 2020/0047; F28D 20/0034

(57) ABSTRACT

Heat storage devices for solar steam generation, including recirculation and desalination, and associated systems and methods are disclosed. A representative method includes directing a high temperature working fluid (a) from a thermal storage device to a solar field to heat the high temperature working fluid, and (b) back to the thermal storage device. The method can further include directing a first portion of the high temperature working fluid from the thermal storage device through a first branch of a high temperature working fluid loop to transfer heat to a process fluid at a first temperature. A second portion of the high temperature working fluid is directed from the thermal storage device through a second branch of the high temperature working fluid loop, in parallel with the first branch, to transfer heat to the process fluid at a second temperature less than the first temperature.

### CROSS-REFERENCE TO RELATED APPLICATIONS

The present application claims priority to pending U.S. provisional application No. 62/594,002, filed Dec. 3, 2017; and pending U.S. provisional application No. 62/643,112, filed Mar. 14, 2018, both of which are incorporated herein by reference.

### TECHNICAL FIELD

The present technology is directed generally to techniques for storing the energy produced by solar concentrators, including methods and devices for economical and robust heat storage, and associated systems.

### BACKGROUND

As fossil fuels become more scarce, the energy industry has developed more sophisticated techniques for extracting fuels that were previously too difficult or expensive to extract. One such technique includes injecting steam into an oil-bearing formation to free up the oil. For example, steam can be injected into an oil well and/or in the vicinity of the oil well. The high temperature of the steam heats up the adjacent formation and oil within the formation, thereby decreasing the viscosity of the oil and enabling the oil to more easily flow to the surface of the oil field. To make the process of oil extraction more economical, steam can be generated from solar power using, for example, solar power systems with concentrators (e.g., mirrors) that direct solar energy to a receiver (e.g., piping that contains a working fluid). The concentrators focus solar energy from a relatively large area (e.g., the insolated area of the mirror) to a relatively small area of the receiver (e.g., axial cross-sectional area of a pipe), thereby producing a relatively high energy flux at the receiver. As a result, the working fluid changes its phase (e.g., from water to steam) while flowing through the receiver that is subjected to a high energy flux. Generally, a steady supply of steam is preferred at an oil field for a steady production of oil. However, the production of steam by solar concentrators is a function of solar insolation, which is intrinsically cyclical (e.g., day/night, sunny/cloudy, winter/summer, etc.). Therefore, in some field applications, the solar power systems include solar heat storage devices that can store excess energy when the insolation is high and release energy when the insolation is small or nonexistent. An example of such a system is described below.

FIG. 1 is a schematic view of a system 10 for generating steam in accordance with the prior art. In the illustrated system, the sun 13 emits solar radiation 14 toward a curved concentrator (e.g., a mirror) 11 that has a line focus corresponding to the location of a receiver 12. As a result, the solar radiation 14 from a relatively large curved concentrator 11 is focused on a relatively small area of the receiver 12. As water W flows through the receiver 12, the highly concentrated solar energy causes a phase change from water W to steam S. A first portion of the steam (S1) is directed to an oil well 18 or its vicinity and a second portion of the steam (S2) is directed to a heat exchanger 15. A valve V maintains a suitable balance between the flows of steam S1 and S2. For example, the valve V can be fully closed when the steam production is relatively low, and all available steam is directed to the oil well 18. When there is excess steam available (e.g., during a period of high insolation), the second portion of steam S2 enters the heat exchanger 15, exchanges thermal energy E with a working fluid WF, which can be, for example, steam or thermal oil, and returns to the entrance of the receiver 12. Depending on the exchange of energy E in the heat exchanger 15, the temperature of the second portion of steam (S2) may still be higher than that of the water W, thereby decreasing the amount of solar energy that the water W would otherwise require to change its phase to steam.

As explained above, when the insolation is relatively high, the temperature of the second portion of steam (S2) is sufficiently high to transfer thermal energy to the working fluid WF in the heat exchanger 15. The working fluid WF then transfers thermal energy to a heat storage unit 16. Conversely, when the insolation is relatively low, the temperature of the second portion of steam (S2) is also relatively low, and the second portion of steam (S2) receives thermal energy from the working fluid WF in the heat exchanger 15. Overall, thermal energy that is stored in the heat storage device 16 when the insolation is relatively high is transferred back to steam when the insolation is relatively low. This transfer of thermal energy to and from the heat storage device 16 promotes a more even flow of the first portion of steam S1 at the oil well 18. Some examples of the prior art heat storage devices are described in the following paragraphs.

FIG. 2 illustrates a portion 20 of a heat storage device in accordance with the prior art. In the portion 20 of the heat storage device (e.g., the heat storage device 16 of FIG. 1), concrete blocks 22 surround pipes 21. When the temperature of the working fluid WF is relatively high, the flow of the working fluid WF through the pipes 21 heats up the adjacent concrete blocks 22. This part of the thermal cycle generally occurs during a period of high insolation. Conversely, when the insolation is low, the concrete blocks 22 heat the working fluid WF, which then transfers energy back to the water/steam in the heat exchanger 15 (FIG. 1). Accordingly, the heat storage device 16 recovers some thermal energy that would otherwise be wasted due to the cyclical nature of insolation. However, the illustrated system has some drawbacks. For example, the pipes 21 are relatively expensive, making the overall heat storage device 16 expensive. Due to a relatively dense distribution of the pipes 21, the amount of working fluid WF contained in the heat storage device 16 can be relatively high which further increases cost of the heat storage device 16. Furthermore, the rate of heat transfer can be poor at the junction between the pipes 21 and the concrete blocks 22, therefore reducing the efficiency of the heat storage process.

FIG. 3 is a partially schematic cross-sectional view of another heat storage device 30 in accordance with the prior art. A first working fluid WF1 (e.g., steam or oil) flows through a piping system 33 and exchanges thermal energy with a second working fluid WF2 (e.g., oil) contained in the heat storage device 30. The second working fluid WF2 can be heated by the first working fluid WF1 during periods of high insolation and the first working fluid WF1 can be heated by the second working fluid WF2 during periods of low insolation. In general, the second working fluid WF2 can absorb relatively large amount of heat without having to be pressurized due to its relatively high heat capacity and boiling point. Because the second working fluid WF2 is generally expensive, relatively inexpensive concrete plates 31 can be inserted in the heat storage device 30 to reduce the required volume of the second working fluid WF2 inside the heat storage device 30. To improve the heat transfer to/from the concrete plates 31, pumps 32 circulate the second working fluid WF2 within the heat storage device 30. However, the flow of the second working fluid WF2 around the concrete plates 31 can still vary significantly, resulting in thermal non-uniformities when heating/cooling the concrete plates 31, thereby reducing the thermal capacity of the system. Furthermore, the pumps 32 are potential points of failure within the overall system. Accordingly, there remains a need for inexpensive and thermally efficient heat storage devices that can facilitate solar heat storage and recovery.

### BRIEF DESCRIPTION OF THE DRAWINGS

FIG. 1 is a schematic view of a system for generating steam in accordance with the prior art.

FIG. 2 illustrates a portion of a heat storage device in accordance with the prior art.

FIG. 3 is a partially schematic cross-sectional view of a heat storage device in accordance with the prior art.

FIGS. 4A-4C are partially schematic cross-sectional views of a heat storage device in accordance with an embodiment of the presently disclosed technology.

FIGS. 5A and 5B are partially schematic views of an arrangement of plates for a heat storage device in accordance with an embodiment of the presently disclosed technology.

FIGS. 6A-6C are schematic views of a mold for manufacturing a heat storage device in accordance with embodiments of the presently disclosed technology.

FIGS. 7A and 7B are partially schematic isometric views of sacrificial sheets used to manufacture heat storage devices in accordance with embodiments of the presently disclosed technology.

FIGS. 8A and 8B are partially schematic isometric views of a heat storage device in accordance with an embodiment of the presently disclosed technology.

FIG. 9 is a schematic illustration of an arrangement of heat storage devices in accordance with an embodiment of the presently disclosed technology.

FIG. 10 is a graph illustrating massflow and heat flux as a function of the number of passes through a heat exchanger configured in accordance with some embodiments of the present technology.

FIG. 11 is a partially schematic illustration of a high temperature working fluid (HTWF) heat exchanger having a recirculation path in accordance with some embodiments of the present technology.

FIGS. 12A and 12B are graphs illustrating temperature and mass flow rate profiles for a representative heat exchanger in accordance with some embodiments of the present technology.

FIG. 13 is a schematic illustration of a counterflow heat exchanger configured in accordance with some embodiments of the present technology.

FIG. 14 is a schematic illustration of a parallel flow heat exchanger configured in accordance with some embodiments of the present technology.

FIG. 15 is a graph illustrating temperature profiles for a representative heat exchanger in accordance with some embodiments of the present technology.

FIGS. 16A-16D are partially schematic illustrations of systems incorporating a high temperature working fluid and a once-through feed water arrangement in accordance with some embodiments of the present technology.

FIGS. 17A and 17B illustrate solar enclosures configured in accordance with some embodiments of the present technology.

FIG. 18 compares mass per unit enclosure area for the systems shown in FIGS. 17A and 17B.

FIG. 19 is a partially schematic, cross-sectional illustration of a thermal storage unit configured in accordance with some embodiments of the present technology.

FIGS. 20A and 20B are partially schematic, cross-sectional illustrations of a thermal storage unit configured in accordance with embodiments of the present technology.

FIG. 21 illustrates details of the composition of a vessel wall configured in accordance with embodiments of the present technology.

FIGS. 22A and 22B illustrate dimensions and selected properties of thermal storage units configured in accordance with embodiments of the present technology.

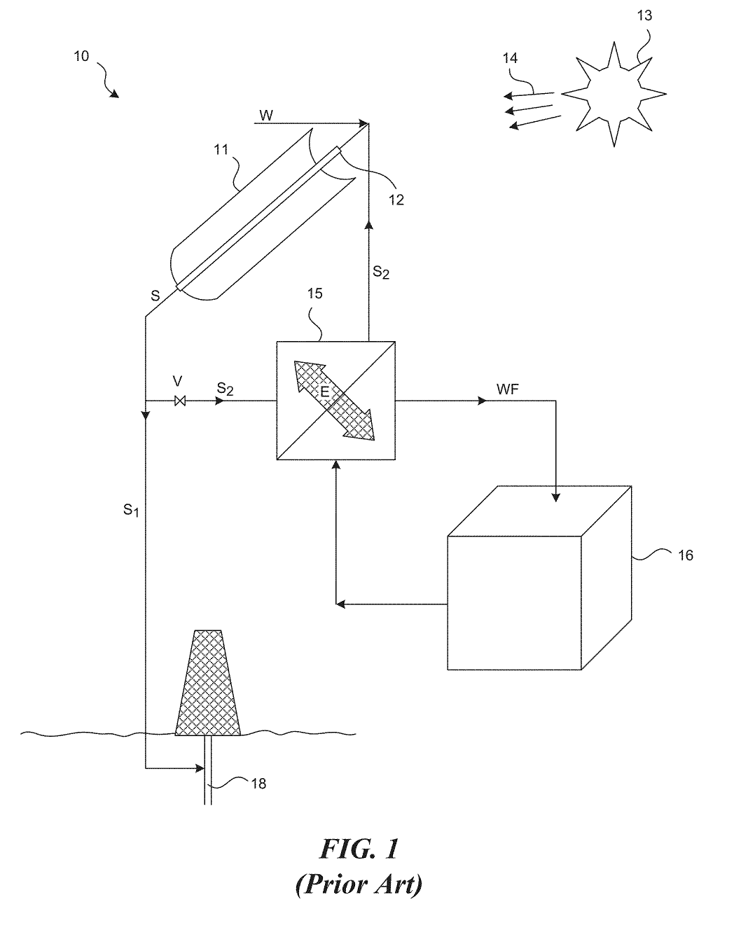

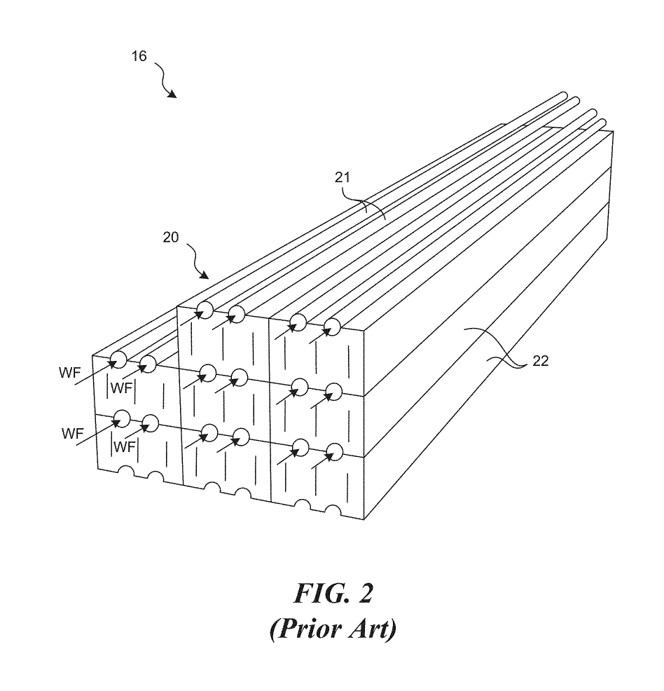

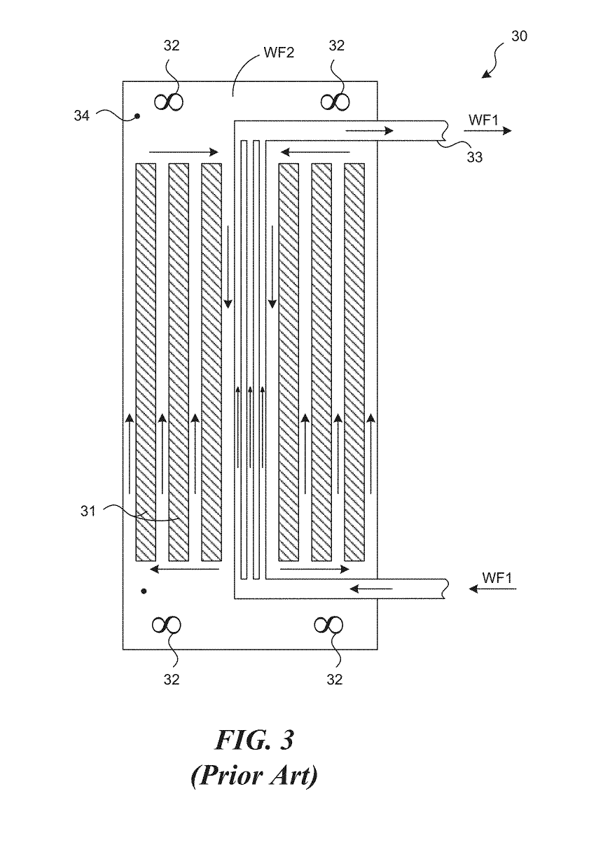

### DETAILED DESCRIPTION

### 1.0 Introduction

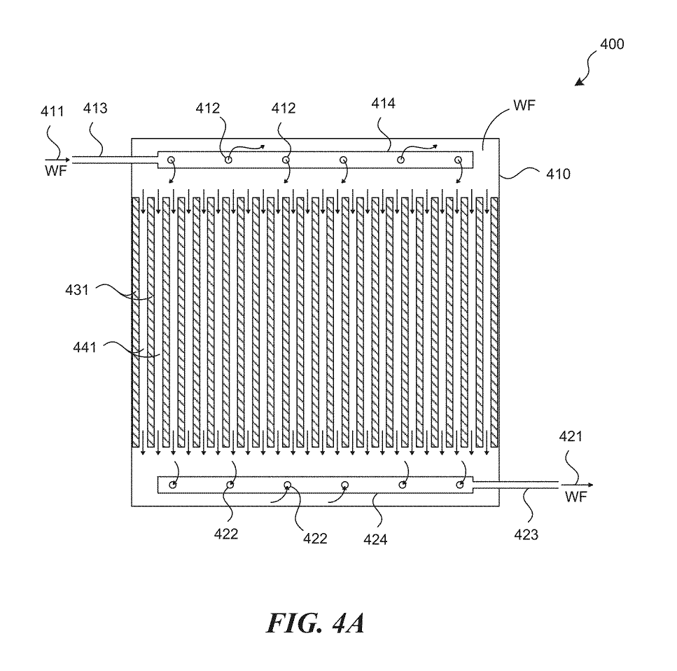

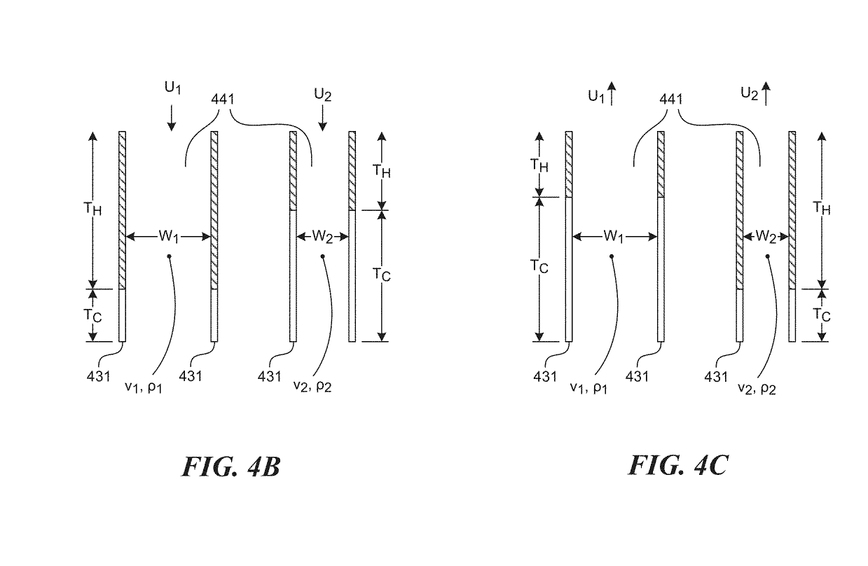

Specific details of several embodiments of representative heat storage technologies and associated systems and methods for manufacture and use are described below. Heat storage technology can be used in conjunction with solar energy systems in oil fields, electrical power generation, residential or industrial heating, and other uses. Embodiments of the present technology can be used to store excess energy at, for example, periods of high insolation, and also for supplementing production of steam at, for example, periods of low insolation. A person skilled in the relevant art will also understand that the technology may have additional embodiments, and that the technology may be practiced without several of the details of the embodiments described below with reference to FIGS. 4A-22B.

Briefly described, methods and systems for storing thermal energy (heat) are disclosed The disclosed methods and systems enable cost effective and robust storage/recovery of heat energy. In contrast with the conventional heat storage devices described above, embodiments of the present technology use thin members (e.g., thin plates) that are spaced closely together. The relatively thin members (e.g., thin concrete plates) have a more uniform temperature distribution in the thickness direction than do thicker plates. As a result, the thin plates can store larger amounts of heat per unit weight, with the entire cross-section of the plates being at or close to isothermal conditions. Such plates can store and release heat faster because the final temperature gradient is established faster for a thin plate than for a thick plate made of the same material. Additionally, the relatively thin, closely spaced plates have a relatively large area for heat exchange, resulting in a faster heat storage/release process. Furthermore, the disclosed methods and systems control the flow of the working fluid (e.g., a thermal oil) to be within a generally laminar flow regime, which is beneficial because the pressure drops in the laminar flow regime are smaller than those associated with turbulent flow regimes. In contrast with the present technology, conventional technologies rely on turbulent flows that result in higher coefficients of heat transfer (generally a desirable outcome), but at the cost of significantly higher pressure drops in the system. With the present technology, the laminar flow is facilitated by generally small distances between the adjacent plates and, at least in some embodiments, by controllers that limit the flow rate of the working fluid in the spaces between the adjacent plates. In several embodiments, the potential downside of the lower heat transfer coefficient of the laminar flow is more than offset by the benefit of the lower pressure drops in the system.

In some embodiments of the present technology, the thin plates can be manufactured at the installation site. For example, a sacrificial material (e.g., wax sheets) can be spaced apart within a mold and then concrete can be added into the mold. After the concrete in the mold solidifies (e.g., to form concrete plates), the sacrificial material can be removed (e.g., by melting). Manufacturing at the installation site reduces the transportation costs for the generally large and heavy heat storage devices. In at least some embodiments, the sacrificial material can have apertures that enable interconnections between the concrete plates in the mold. After the concrete poured in the mold solidifies and the sacrificial material is removed, the interconnected concrete plates can have (1) improved crack resistance due to additional structural strength of the connections between the plates, and/or (2) improved heat transfer due to the additional heat transfer area that the connections create in the flow of working fluid.

Many embodiments of the technology described below may take the form of computer- or controller-executable instructions, including routines executed by a programmable computer or controller. Those skilled in the relevant art will appreciate that the technology can be practiced on computer/controller systems other than those shown and described below. The technology can be embodied in a special-purpose computer, controller or data processor that is specifically programmed, configured or constructed to perform one or more of the computer-executable instructions described below. Accordingly, the terms “computer” and “controller” as generally used herein refer to any data processor and can include Internet appliances and hand-held devices (including palm-top computers, wearable computers, cellular or mobile phones, multi-processor systems, processor-based or programmable consumer electronics, network computers, mini computers and the like). Information handled by these computers can be presented at any suitable display medium, including a CRT display or LCD.

The technology can also be practiced in distributed environments, where tasks or modules are performed by remote processing devices that are linked through a communications network. In a distributed computing environment, program modules or subroutines may be located in local and remote memory storage devices. Aspects of the technology described below may be stored or distributed on computer-readable media, including magnetic or optically readable or removable computer disks, as well as distributed electronically over networks. Data structures and transmissions of data particular to aspects of the technology are also encompassed within the scope of the embodiments of the technology.

### 2.0 Representative Heat Storage Devices

FIG. 4A is a partially schematic cross-sectional view of a heat storage device 400 configured in accordance with an embodiment of the presently disclosed technology. The heat storage device 400 can include plates 431 (e.g., concrete plates) spaced apart and arranged in a housing 410, an inlet pipe 413 connected to an inlet manifold 414, and an outlet pipe 423 connected to an outlet manifold 424. In some embodiments, the plates 431 can be generally parallel and equidistant. In operation, a flow (indicated by a flow arrow 411) of the working fluid WF (e.g., thermal oil) can enter the heat storage device 400 through the inlet pipe 413. In some embodiments, the inlet manifold 414 has a larger cross section than that of the inlet pipe 413. Therefore, as the working fluid WF enters the inlet manifold 414, the velocity of the working fluid WF decreases and the pressure increases, resulting in a more uniform discharge of the working fluid through openings 412 spaced along the manifold 414. As a result, the flow of the working fluid leaving the manifold 414 and approaching the plates 431 can also be more uniform.

Channels 441 between the adjacent plates 431 can be sized to facilitate a predominantly laminar flow in the channels. For example, in some embodiments the velocity of the working fluid and spacing between the plates 431 can be selected such that the Reynolds number (i.e., [velocity of the fluid]×[characteristic dimension of the flow passage]/[kinematic viscosity of the fluid]) is smaller than 2,000-5,000. The term “predominantly laminar” in this disclosure encompasses flows that may be turbulent or separated in some regions, e.g., close to the outer edges of the plates 431, but are mostly laminar between the plates 431. In some embodiments of the present technology, the spacing between the adjacent plates 431 (i.e., the width of the channels 441) can be 1-2 mm. Such a spacing between the plates can also prevent an excessively low Reynolds number (e.g., less than about 3), where the viscous forces would dominate the flow and the flow between the plates 431 would be too slow.

The predominantly laminar flow in the flow channels 441 can result in relatively low pressure drops within the heat storage device 400. As a result of the relatively low pressure drops, the thermal performance of the heat storage device 400 can be less sensitive to imperfections and nonuniformities in the size/shape of the channels 441. That is, the velocity of the working fluid varies with the nonuniformities in the size/shape of the channels 441, but these variations are generally less pronounced for laminar flow than for turbulent flow. Since the heat transfer to/from the plates 431 is a function of the velocity of the working fluid, the variations in the heat transfer to/from the plates 441 will also be smaller as a result of the laminar flow in the channels 441.

After flowing through the channels 441 the working fluid WF can enter the outlet manifold 424 through openings 422. As explained in relation to the inlet manifold 414, a relatively large diameter of the outlet manifold 424 reduces the velocity of the working fluid therefore increasing the uniformity of the flow across the heat storage device 400. The working fluid WF can leave the heat storage 400 through the outlet pipe 423 as indicated by a flow arrow 421, and can flow back to the solar heating system.

As described above, the plates 431 can be relatively thin. For example, in some embodiments, the thickness of an individual plate 431 can be 10-20 or 20-30 mm. The relatively thin plates 431 produce a relatively large overall plate surface area for a given volume of the heat storage device 400. Since heat is transferred between the working fluid WF and the plates 431 through the surface area of the plates 431, a large total surface area of the plates 431 (relative to their volume) improves the transfer of heat into and out of the plates. This improved heat transfer can, for example, reduce the time to fully warm up or cool down plates 431, thereby increasing the thermal efficiency of the heat storage device 400. Furthermore, the temperature gradients in the thickness direction of the plates 431 are expected to be more uniform from one plate to another than for thick plates. For an individual plate, the temperature gradients are expected to be shallower, allowing the thin plates to reach equilibrium more quickly than would the thick plates. In at least some embodiments, the plates may be designed to have a temperature distribution in the direction of the thickness of the plate within +/−5% or +/−1% of the average temperature in the direction of thickness at a given height of the plate (i.e., the temperature being within 5% or 1% of the isothermal condition in the direction of the thickness). In other embodiments the temperature distributions can be different, for example, the temperature distribution can be within +/−10% of the average temperature in the direction of the thickness of the plate. With the thick plates used in the conventional technology, such a narrow temperature distribution across the thickness of the plates is generally not achievable within the typical daily insolation cycles.

In at least some embodiments, the working fluid WF can withstand relatively high temperatures (e.g., 300° C. or higher) without being pressurized, so as to transfer a large amount of energy to the plates 431. In some embodiments, the working fluid WF can be a molten salt capable of operating at even higher temperatures (e.g., 500° C. or higher). An optional coating, cladding or other encapsulant or enclosure can provide insulation around all or a portion of the heat storage device 400. For example, the insulation can include an air barrier, woven insulation, blown insulation, a ceramic barrier, and/or another suitable configurations.

FIGS. 4B and 4C are partially schematic views of the plates of a heat storage device 400 configured in accordance with an embodiment of the presently disclosed technology. Collectively, FIGS. 4B and 4C illustrate balancing the flow of the working fluid through the channels 441. In at least some embodiments, the direction of the flow of the working fluid can be downward when the working fluid transfers heat to the plates 431 (e.g., when the insolation is relatively high), and upward when the plates 431 transfer heat to the working fluid (e.g., when the insolation is relatively low). For example, the direction of the flow in FIG. 4B is from the top to the bottom, which can be representative of the plates 431 being heated by the working fluid (e.g., the working fluid is warmer than the plates 431). The direction of the flow in FIG. 4C is from the bottom to the top, that is the plates 431 can be cooled down by the working fluid (e.g., the working fluid is colder than the plates 431). The direction of the gravitational force is from the top to the bottom in both FIGS. 4B and 4C. The channels 441 can have a non-uniform width due to, for example, manufacturing errors or tolerances. For example, in FIGS. 4B and 4C the leftmost channels have width W₁ that is larger than the width W₂ of the rightmost channels. Generally, relatively wide channels having width W₁ would result in a relatively larger working fluid velocity U₁ due to smaller pressure drops associated with the wider channels. Conversely, relatively narrow channels having width W₂ would result in a relatively smaller working fluid velocity U₂. Such a non-uniformity in the working fluid velocity may be undesirable because, for example, some plates 431 would be heated/cooled too fast or too slow in comparison with the other plates 431. For example, during a heating cycle, a plate 431 that is adjacent to a wide channel, may be heated faster than the rest of the plates in the thermal storage 400, leading to a flow of the warm working fluid through the wide channel that, at least for a part of the cycle, does not transfer heat from the working fluid to the plate (e.g., after the plate is fully warmed up). The undesirable non-uniformities in the working fluid flow/plate temperature can be at least partially offset as explained below.

As explained above, a channel with a larger width W₁ generally promotes a relatively larger working fluid velocity U₁, and a narrower channel width W₂ generally promotes a relatively smaller working fluid velocity U₂. In at least some embodiments, for the relatively thin plates 431 the heat transfer from the working fluid to the plates can be relatively fast, i.e., the plates reach the temperature of the working fluid relatively fast. For example, in FIG. 4B the higher fluid velocity U₁ heats the vertical length of the plates in the channel (e.g., the leftmost plate) faster than the lower fluid velocity U₂ (e.g., the rightmost plate). As a result, the portion of the vertical length of the plates 431 at a relatively high temperature T_{H} is larger for the plates of the wider channel W₁ than the corresponding portion T_{H} for the plates of the narrower channel W₂. The working fluid at a higher temperature also has a lower viscosity and lower density than the working fluid at a lower temperature. Therefore, an overall relatively warmer fluid in the channel W₁ has overall relatively smaller viscosity v₁ and smaller density ρ₁ in comparison to the (overall) relatively colder fluid in the channel W₂. The lower viscosity v₁ corresponding to the working fluid in the channel W₁ further promotes faster velocity of the working fluid in comparison to the working fluid in the channel W₁. However, the overall warmer fluid in the channel W₁ also experiences a higher buoyancy, which can at least partially counteract the higher velocity of the working fluid in the channel W₁. Namely, the flow direction that the buoyancy promotes is from the bottom to the top, i.e., in the direction opposite from the direction of the gravitational force. Due to a relatively smaller density ρ₁ in the channel the buoyancy effect will be more pronounced in the channel W₁ than in the channel W₂. Therefore, in at least some embodiments of the present technology, the buoyancy of the working fluid in the channels 431 can make the flow in the channels having different widths (e.g., W₁ and W₂) at least substantially uniform.

In FIG. 4C, the flow of the working fluid in the two channels having different widths (W₁ and W₂) is from the bottom of the page to the top of the page, and is opposite from the direction of the gravitational force. As explained above, the pressure drop coefficient for a wider channel is generally smaller than the pressure drop coefficient for a corresponding narrow channel, thus generally promoting a higher working flow velocity in the wider channel. In some embodiments, the working fluid entering the channels can be colder than the plates 431, therefore heat is transferred from the plates 431 to the working fluid. As explained above, cooling the plates 431 with a relatively faster flow velocity U₁ in the wide channel W₁ generally results in a longer vertical length of the plates 431 being at a relatively cold temperature T_{C}. Conversely, a relatively slower flow velocity U₂ in the narrow channel W₂ results in a shorter length of the plates 431 being at a relatively cold temperature T_{C}. Since the density of the working fluid in the channels 441 is proportional to the (overall) temperature of the working fluid in the channel, an average density ρ₁ of the working fluid in the wider channel W₁ is higher (due to the overall lower temperature of the working fluid) than the corresponding average density ρ₂ of the working fluid in the more narrow channel W₂ (due to the overall higher temperature of the working fluid). For a vertical column of the working fluid, the relatively higher density p results in a relatively higher pressure head in the wider channel W₁, and the relatively lower density ρ₂ results in a relatively lower pressure head in the narrower channel W₂. As a result, the higher pressure head in the wider channel W₁ tends to reduce the working fluid velocity U in the wider channel, and the lower pressure head in the narrower channel W₂ tends to promote (increase) the working fluid velocity U₂ in the narrower channel. As a consequence, the differences in the pressure heads of the wider channel W₁ and narrow channel W₂ promote a generally uniform flow (or at least a more uniform flow) within the channels having different widths.

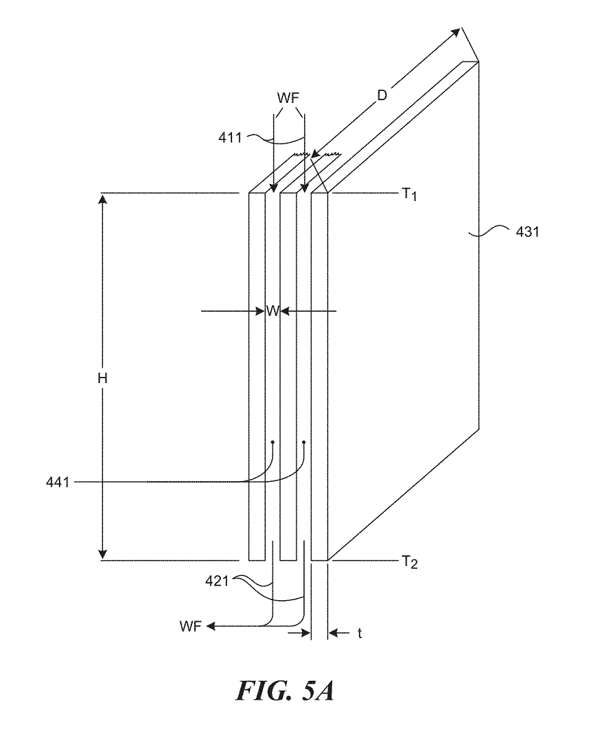

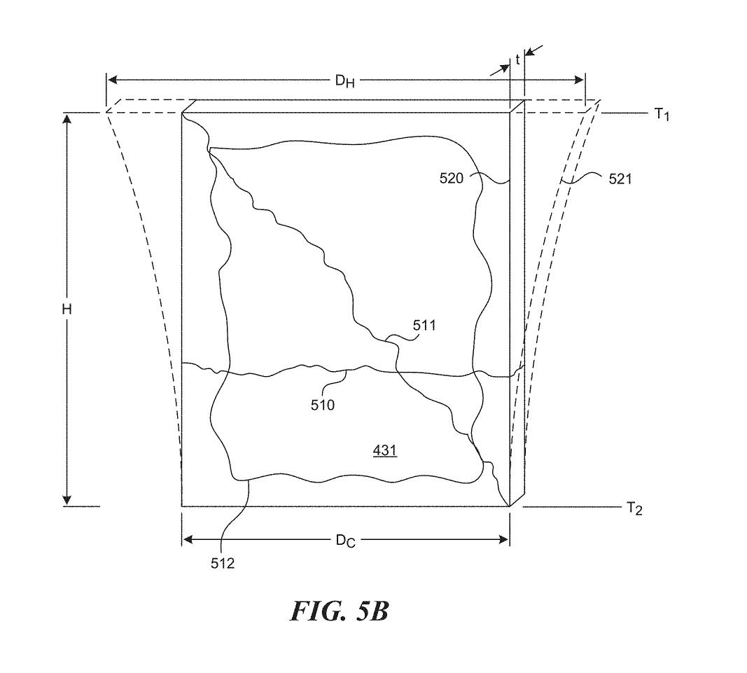

FIGS. 5A and 5B are partially schematic views of an arrangement of plates for a heat storage unit in accordance with an embodiment of the presently disclosed technology. FIG. 5A illustrates the plates 431, e.g., concrete plates. FIG. 5B schematically illustrates the expected thermal expansion of a plate 431 as it undergoes heating during normal use. In a particular embodiment, the individual concrete plates 431 are 0.5-1.5 m deep (D), 2.5-5 m high (H) and 10-30 mm thick (d), and the plates can have other suitable dimensions in other embodiments. In operation, the working fluid WF enters the channels 441 between the adjacent plates 431 as indicated by the flow arrow 411, and leaves as indicated by the flow arrows 421. Therefore, in the illustrated embodiment the working fluid WF flows inside the channels 441 primarily in the direction of the height H. In some embodiments, due to a generally steady flow in the individual channels 441, the temperature of the plates 431 changes uniformly from T₁ to T₂ in the direction of the flow (with T₁ generally higher than T₂ when the insolation is high, and vice versa when the insolation is low). In at least some embodiments, it is desirable that the velocity and temperature of the working fluid do not vary from one channel to another, or at least do not vary significantly, and for the individual plates 431 to have the same or comparable temperature profiles (e.g., the same or comparable temperature gradient from T₁ to T₂). Therefore, in at least some embodiments, a distance between the adjacent plates 431 (i.e., the width W of the channels 441) is generally same (aside from, e.g., manufacturing errors and tolerances) to promote the same flow rates in the channels 441 and the same temperature profiles in the plates 431.

FIG. 5B schematically illustrates an expected thermal expansion of a plate 431 in accordance with an embodiment of the presently disclosed technology. As explained above, the widths of the channels 441 between neighboring plates 431 can be designed and formed to be generally constant. However, cracks that develop in the plate 431 (e.g., due to thermal stresses or vibrations) may change the channel widths. With some cracks, a section of the plate 431 may become offset from the principal plane of the plate therefore changing the effective width of the channel 441. For example, a crack 512 may separate a section of the plate 431 from the rest of the plate. Under some conditions, the separated section of the plate can move out of the principal plane of the plate (e.g., out of the plane of the page in FIG. 5B) to create a wider channel on one side of the plate 431 and a narrower channel on the opposite side of the plate 431, thereby affecting the uniformity of the flow in the channels. To counteract this problem, the present technology can include one or more preferred direction(s) for crack development, as explained below.

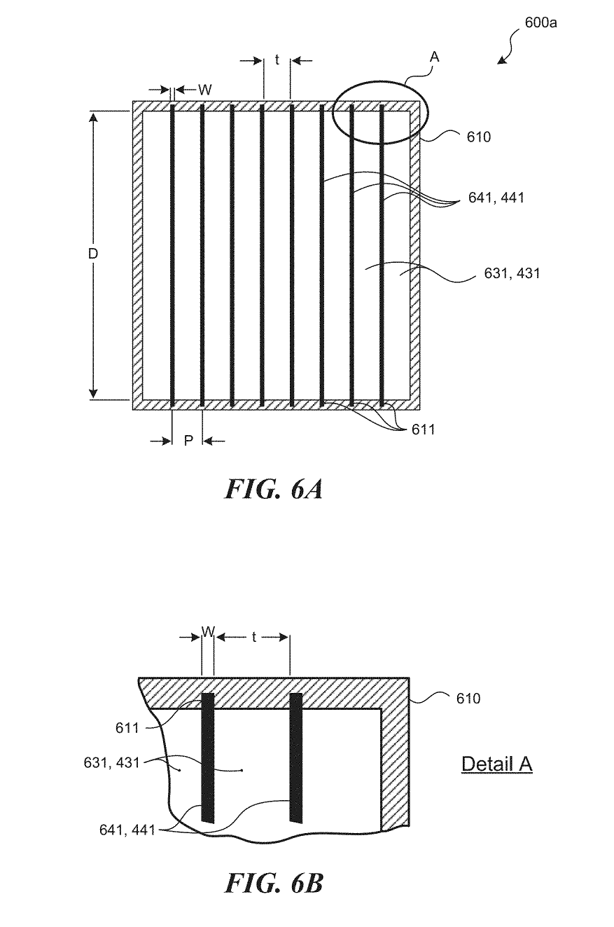

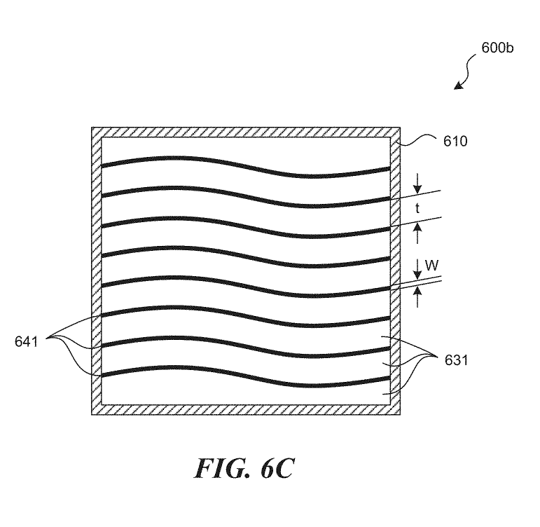

In FIG. 5B, an initial outline 520 of the unheated plate 431 is illustrated with a solid line. As the working fluid travels downwardly in the channels 441 (in the direction of the height H), the working fluid heats the plate 431. The upper portion of the plate achieves a higher temperature (T₁) than the temperature T₂ of the lower portion of the plate. The resulting outline of the plate 431 is illustrated (in an exaggerated manner for purposes of illustration) with a dashed line 521, and indicates that the upper portion of the plate 431 has a depth DH that is larger than a depth Dc at the lower portion of the plate. The difference between the depths Du and Dc can promote diagonal cracks 511 that extend diagonally across the plate. Such diagonally extending cracks 511 in general do not promote separation of the sections of the plate out of the principal plane of the plate. In some embodiments, the plate 431 may be purposely weakened (e.g., thinned), to create a preferred direction for a crack 510 to propagate (e.g., by shaping the wax sheet described below with reference to FIGS. 6A-6C). The cracks 510 and 511 do not (or at least do not significantly) promote separation of the sections of the plate that could change the width of the channels for the working fluid. Therefore, even when the plate 431 includes cracks 510 and/or 511, the channel width remains generally constant and the flow of the working fluid remains generally the same in the individual channels.

FIG. 6A is a schematic view of a mold 600a for manufacturing a heat storage device in accordance with an embodiment of the presently disclosed technology. FIG. 6B is a detailed view of a portion of the mold 600a. FIGS. 6A and 6B are discussed together below. The mold 600a can include a mold housing 610 that contains sacrificial sheets 641 (e.g., formed from a meltable wax) arranged at a spacing or pitch P. In some embodiments of the present technology, an arrangement of supporting structures, for example grooves 611, can maintain the sacrificial sheets 641 at a required spacing. In other embodiments, clips or holders or other suitable devices may be used to hold the sacrificial sheets in place. After arranging the sacrificial sheets 641 inside the mold housing 610, a molding material 631 (e.g., concrete) can be poured into the mold 600a (e.g., into the plane of page). In some embodiments of the present technology, the molding material 631 can be poured between the sacrificial sheets 641 such that an approximately similar amount of the molding material 631 flows into the spaces between the sacrificial sheets 641. As a result, a pressure of the concrete on the two opposing sides of the sacrificial sheets 641 is similar, and the sacrificial sheets 641 generally maintain their initial position and shape during the molding process. In other embodiments, the mold 600a can be turned on its side such that the sacrificial sheets 641 are horizontal. The molding process can start by adding an amount of the molding material 631 to cast one plate 431. Next, a sacrificial sheet 641 can be placed over the already added molding material, followed by adding an amount of the molding material that is sufficient to cast another plate 431. The process can then be repeated for the number of required plates 431.

When the molding material 631 solidifies, the sacrificial sheets 641 can be removed by, for example, melting them at a sufficiently high temperature (e.g. when the sacrificial sheets are made of a meltable wax or other material. In some embodiments, the sacrificial sheets may be removable by a chemical reaction that, for example, dissolves or gasifies the sacrificial sheets 641. A depth D of the sacrificial sheets 641 generally corresponds to a depth D of the channels 441. In any of the above embodiments, after the molding material 631 solidifies, the plates 431 can be removed by, for example, disassembling the mold housing 610. An advantage of embodiments of the present technology is that relatively thin plates 431 can be created without having to machine the concrete. Furthermore, in at least some embodiments of the present technology, the illustrated molding process can be performed at the site, resulting in reduced transportation costs and delays.

FIG. 6C is a schematic view of a mold 600b for manufacturing a heat storage device in accordance with an embodiment of the presently disclosed technology. The mold 600b can include a mold housing 610 that contains sacrificial sheets 641 (e.g., formed from meltable wax or plastic). The sacrificial sheets 641 can be arranged generally horizontally, but do not need to be necessarily horizontal and can be generally wavy. In an embodiment of the present technology, the process for manufacturing the plates 631 can start with pouring concrete at the bottom of the mold housing 610, followed by placing down a sacrificial sheet 641 (or pouring the material of the sacrificial sheet 641) over the concrete. Next, an additional layer of concrete (or other plate material) can be poured, followed by an additional sacrificial sheet 641, and the process continues. After the concrete (or other material of the plates 631) solidifies, the sacrificial sheets 641 are removed by, for example, melting or chemical reaction. The resulting channels (where the sacrificial sheets 641 used to be) can have a generally constant width W. Therefore, for a flow of the working fluid in and out of the page, even though the channel may be wavy, the width W of the channel is essentially constant (other than for manufacturing or tolerance variations). In at least some embodiments, not having to produce flat plates may simplify the manufacturing process and/or make it more robust.

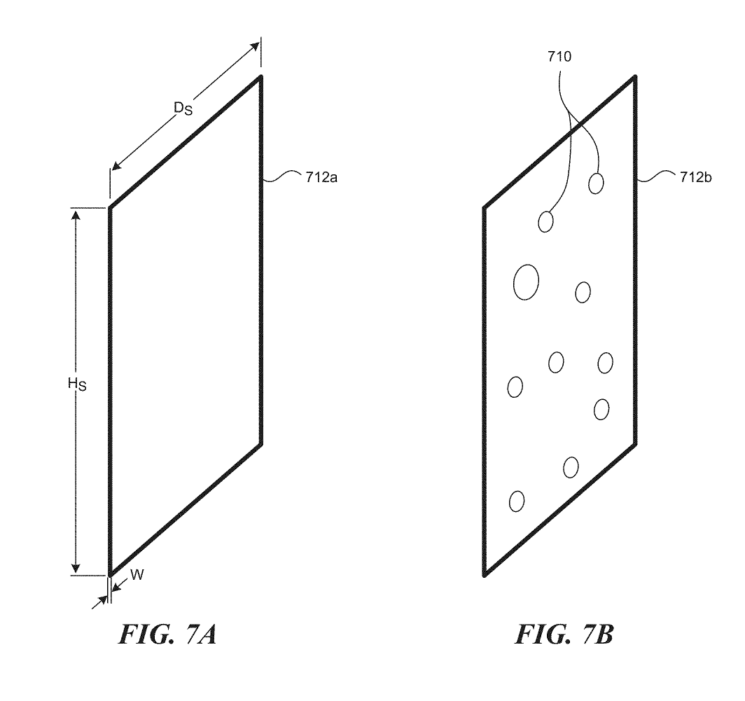

FIGS. 7A-B are partially schematic isometric views of sacrificial sheets configured in accordance with embodiments of the presently disclosed technology. FIGS. 7A, 7B illustrate sacrificial sheets 712a, 712b, respectively, having a depth Ds and a height Hs that generally determine the depth/height of the corresponding channels of the heat storage device. In an embodiment shown in FIG. 7A, the sacrificial sheet 712a is generally solid. As a result, the molded plates have side surfaces that are generally flat and are not connected to the adjacent plates. In an embodiment shown in FIG. 7B, the sacrificial sheet 712b includes openings 710 that, during the molding process, allow a flow of the molding material through the openings 710 from a space occupied by one plate to a space occupied by an adjacent plate. As a result, the side surfaces of the adjacent plates in the mold can be connected by the mold material in the openings 710. After the sacrificial material is removed (e.g., by melting), the connections between the adjacent plates remain in place. Generally, the connections can add structural strength and can reduce cracking of the otherwise relatively slender plates. Additionally, in operation, when the working fluid flows in the channel, the fluid also flows around the connections between the adjacent plates. Therefore, the connections can provide an additional area for the heat exchange between the working fluid and the plates. Furthermore, the connections can maintain the designed spacing between plates, and therefore the widths of the flow channels between plates. The illustrated openings 710 are generally oval, but can have other shapes (e.g., slits oriented in the direction of flow) in other embodiments.

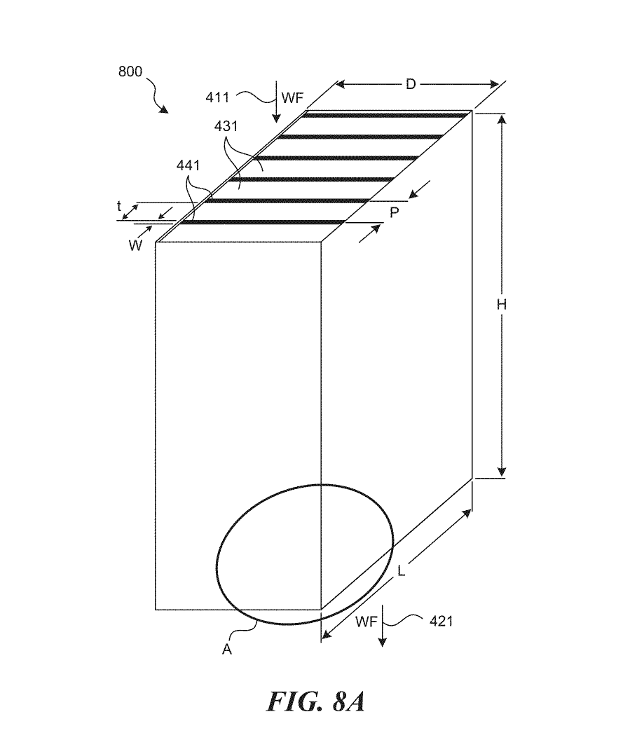

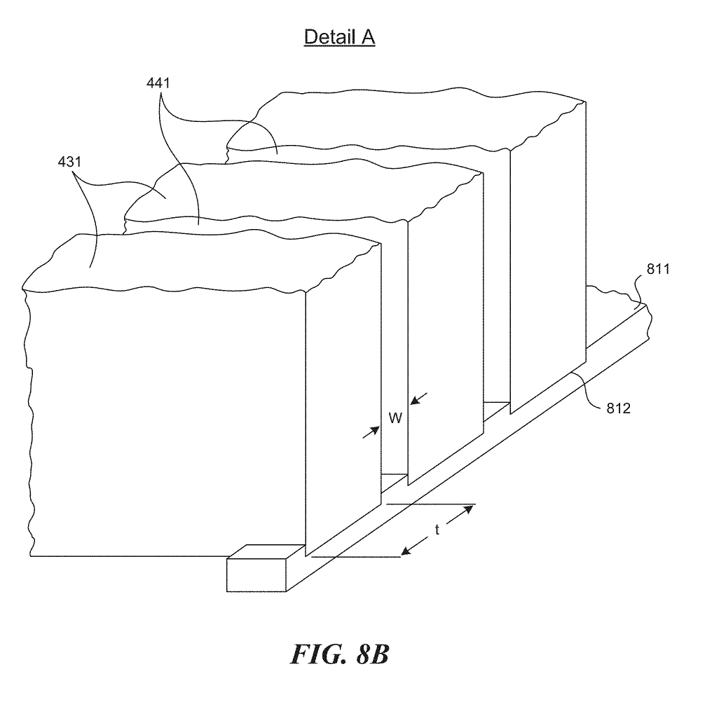

FIG. 8A is a partially schematic isometric view of a heat storage device 800 configured in accordance with an embodiment of the presently disclosed technology. FIG. 8B is a detailed view of a portion of the heat storage device 800. The illustrated heat storage device 800 includes several plates 431 arranged along a length L. The plates 431 have a thickness t, a depth D and a height H. The spaces between the adjacent plates corresponds to the width W of the channels 441. A distance between the consecutive channels 441 is a pitch P. Flow arrows 411, 421 indicate the direction of flow of the working fluid WF. In operation, the working fluid WF can flow through the channels 441 from the top to the bottom of the heat storage device 800 to transfer heat to/from the plates 431. The working fluid WF leaves the heat storage device 800 at the bottom, as illustrated by the flow arrow 421.

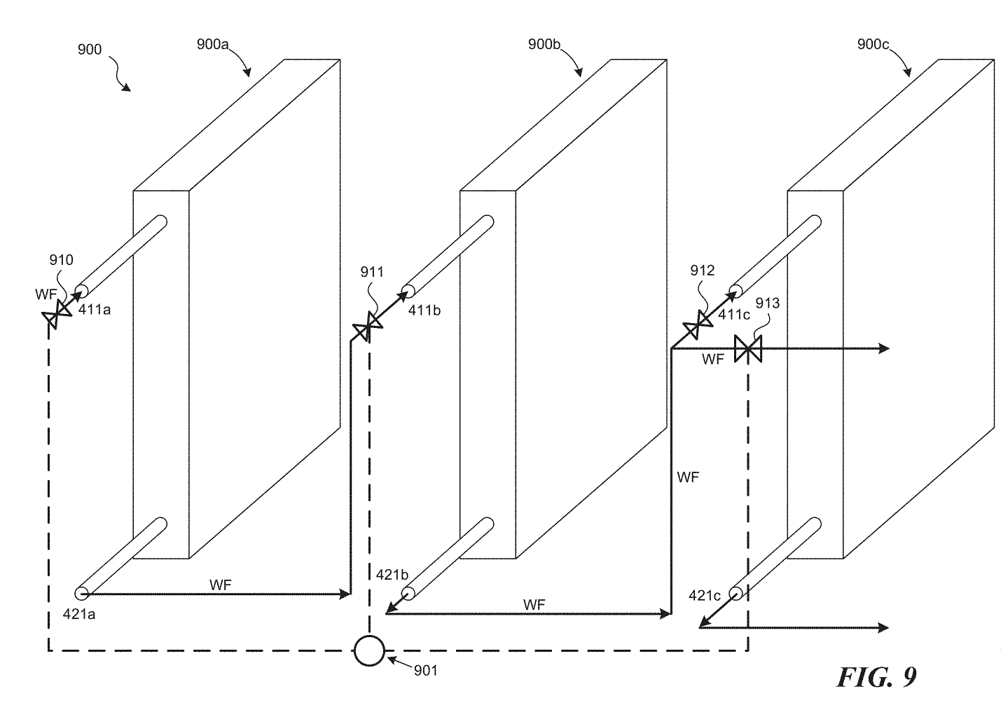

FIG. 8B illustrates a portion of an arrangement of the plates 431. In the illustrated embodiment, a base plate 811 supports the plates 431 inside corresponding base grooves 812. A width of the base grooves 812 is generally the same as the thickness of the plates 431. In other embodiments, the width of the base grooves can be larger than the thickness of the plates 431. In some embodiments, additional base plates 811 can support the plates 431 at, for example, corners of the plates 431 to maintain a generally vertical position of the plates 431. A distance between the adjacent base grooves 812 can at least in part determine the width W of the channels 441. In some embodiments of the present technology, the base plate 811 can be manufactured from the same material as the plates 431 (e.g., from concrete) for lower cost and shorter lead times. Depending on a required amount of steam at the oil field or in other field use, a single heat storage device 800 may not have sufficient capacity and, therefore, multiple heat storage devices 800 may be arranged together, as explained below with reference to FIG. 9.

FIG. 9 is a schematic illustration of an arrangement 900 of multiple heat storage devices in accordance with an embodiment of the presently disclosed technology. The illustrated embodiment includes three heat storage devices (indicated as first-third devices 900a-900c), and in other embodiments, the arrangement can include other numbers of heat storage devices, depending (for example) on the overall heat storage capacity needs of a particular application. In any of these embodiments, when the solar insolation is relatively high, the working fluid generally (e.g., for most of the time) transfers heat to the plates inside the heat storage. Conversely, when the solar insolation is relatively low, the plates generally transfer heat to the working fluid.

In the illustrated arrangement 900, the working fluid WF can enter the first heat storage 900a as indicated by flow arrow 411a at the top of the unit, and leave as indicated by flow arrow 421a at the bottom of the unit when the working fluid WF transfers heat to the plates of the heat storage 900a. The heat storage devices 900a-900c are arranged in series, e.g., the working fluid WF flows from the outlet of the first heat storage device 900a to the inlet of the second heat storage device 900b (arrow 411b), and, after exiting the second heat storage device 900b (arrow 421b), further to the inlet of the third heat storage device 900c (arrow 411c), and from the exit of the third heat storage device 900c (arrow 421c). Such an arrangement of the flow of the working fluid WF through the heat storage devices 900a-900c can correspond to a relatively high insolation. Conversely, when the insolation is relatively low, the flow of the working fluid WE can enter the first heat storage device 900a at the bottom, flow through the first heat storage device 900a while receiving heat from the plates in the first heat storage device 900a, exit the first heat storage device 900a at the top, and enter at the bottom of the second heat storage device 900b, and go on to the third heat storage device 900c.

The arrangement 900 is a sample arrangement of heat storage devices, and other field-specific serial/parallel arrangements can be used in other embodiments. Furthermore, the three heat storage devices are illustrated as having generally the same shape and size, but the heat storage devices can have different shapes and/or sizes in other embodiments.

The arrangement 900 can include valves positioned to regulate amount of the working fluid flowing through any one or combination of heat storage devices. In some embodiments, the valves can be controlled by a controller 901 to limit or stop the flow of the working fluid to some of the heat storage devices, depending on, for example, insolation and required production of the steam in the field. In other embodiments, the controller 901 can control valves 910-913 to maintain a laminar or generally laminar flow through the heat storage devices of the arrangement 900, or at least through some heat storage devices. In other embodiments, the arrangement can include other numbers and/or locations of the valves. The controller 901 may include a computer-readable medium (e.g., hard drive, programmable memory, optical disk, non-volatile memory drive, etc.) that carries computer-based instructions for directing the operation of the valves 910-913 and/or other components of the assembly and/or larger system. More generally, when the heat storage device(s) are integrated with other system components (e.g., solar fields, heat exchangers, turbines, and/or other process equipment), the controller can control the functioning of the additional components and the overall system.

### 3.0 Representative Heat Storage System Arrangements

As discussed above, systems in accordance with some embodiments of the present technology can include a working fluid that in turn includes a molten salt or other high-temperature fluid. The molten salt can be routed through the solar field in a closed loop to absorb solar radiation, and can transfer the absorbed heat to water (e.g., in a heat exchanger) to generate steam. An advantage of using a molten salt working fluid is that it can achieve significantly higher temperatures at a given pressure than can steam. The higher temperature (and associated higher temperature difference with the water to which the heat is transferred) can improve overall thermal efficiency. The following sections describe some embodiments of the present technology in which a molten salt or other high temperature working fluid (HTWF) is used. As used herein, the terms “high temperature working fluid” and “HTWF” refer to working fluids having vaporization temperatures higher than those of water.

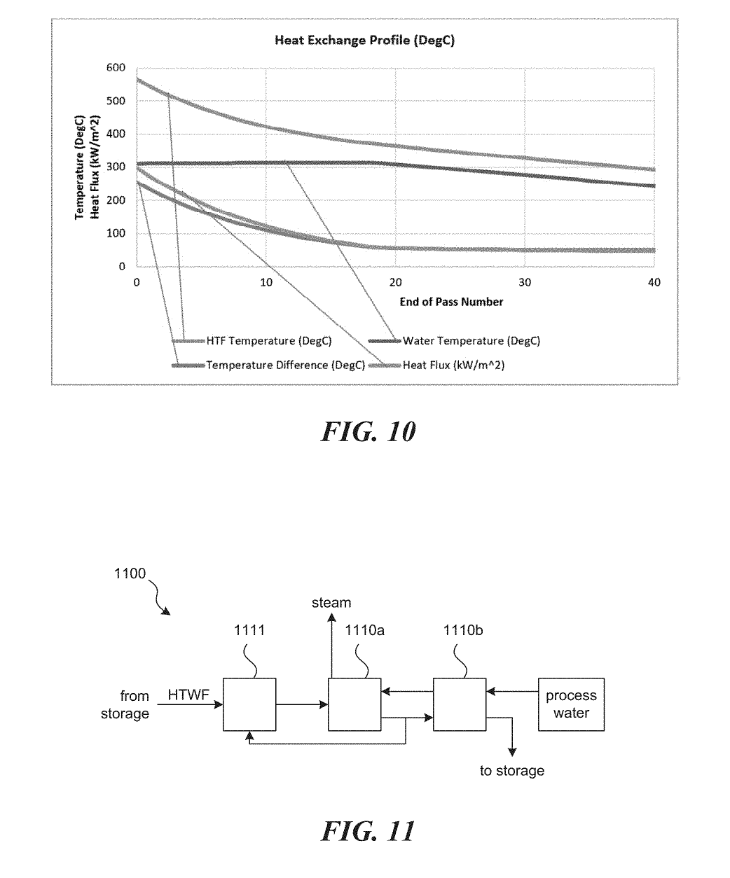

In several applications, such as thermal storage, it is advantageous to heat the HTWF to as high a temperature as possible to reduce the cost of heat storage. However, when evaporating water using the HTWF, the large temperature difference between the HTWF and the water can lead to film boiling and scale formation. FIG. 10 illustrates a simulation of a representative conventional process that exhibits this drawback. The simulation is for a double pipe counterflow heat exchanger (e.g., an inner pipe positioned annularly within an outer pipe). The water flows from right-to-left in the inner pipe and the salt flows from left-to-right in the annulus. The double-pipe makes 40 serpentine passes. Each pass is 12 meters long. The salt enters at 565° C. and exits at 290° C. In 40 passes, a total of 7.5 MW heat is transferred from the salt to the water. The water enters at 240° C. and leaves at 311° C. (as 80% saturated steam). The water enters at a relatively high temperature to avoid freezing the salt when it comes into contact with the 240° C. water tubes. In this simulation, the salt is a 60/40 salt which freezes at 220° C. A 60/40 salt refers to a salt that is 60% NaNO3 and 40% KNO3. The temperature difference between the incoming salt and the exiting water is 254° C., and results in a heat flux of 300 kW/m², which is well above the critical flux required to produce steam of 80% quality. The excess heat flux can produce film boiling and/or scale formation. As a result of film boiling and/or scale formation, this type of arrangement is not generally suitable for producing steam with the foregoing characteristics.

Aspects of the presently disclosed technology can address the problems of film boiling and/or scale formation by one or more of the following techniques: (1) attemperation of the hot HTWF prior to its entry into a steam generator; (2) recirculating part of the colder exhaust HTWF to the entrance of the steam generator for the purpose of attemperation; and/or (3) splitting the steam generator into two units for flexibility of operation.

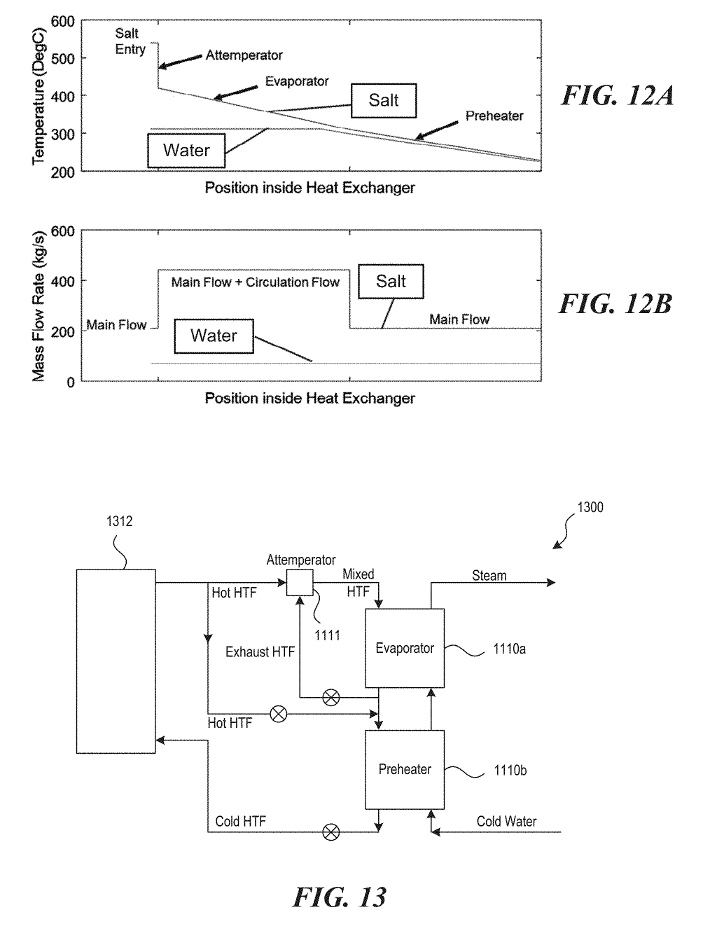

FIG. 11 schematically illustrates a portion of a simplified system 1100 incorporating the above techniques. FIGS. 12A and 12B illustrate the corresponding heat and mass balances through the system. The system includes at least two heat exchangers 1110 (or at least two heat exchanger sections or portions of a single heat exchanger), shown as an evaporator 1110a and a pre-heater 111Ob (FIG. 11). The heat exchangers 1110 transfer heat from an HTWF (which enters from the left) and water (which enters from the right) in a counterflow arrangement. An attemperator 1111 pre-cools the HTWF entering the evaporator 1110a using HTWF that has already passed through the evaporator 1110a. Accordingly, the HTWF can be cooled from an initial temperature of 540° C. (e.g., the temperature of the HTWF as it exits a thermal storage unit) to 420° C. prior to entering into the evaporator 1110a. As a result, the temperature difference between the HTWF entering the evaporator 1110a and the water exiting the evaporator 1110a (at 311° C.) is reduced to only 109° C., which results in a much lower flux of 140 kW/m². This flux value is much more manageable than the flux of 300 kW/m² described above with reference to FIG. 10, and can significantly reduce or eliminate the risks of film boiling. In addition, this approach can enable the use of carbon steel instead of stainless steel, which is about four times as expensive, and is also susceptible to chloride-based corrosion and cracking. A drawback of this approach is that reducing the salt inlet temperature may increase the length of the heat exchanger (e.g., by 60%), which can reduce or eliminate the cost savings achieved by using carbon steel instead of stainless steel. In other words, by reducing the inlet temperature, the heat flux decreases, which is compensated for by increasing the heat transfer area. However, it is estimated that the end result of reducing or eliminating film boiling, scale formation and/or chloride corrosion issues more than offsets this drawback.

In some embodiments, the salt inlet temperature is between 390° and 425° C., and is more generally less than 425° C. because carbon steel starts to graphitize above 425° C. The strength of carbon steel is also greatly reduced above this temperature. The lower bound (390° C.) is also important to control because a lower salt temperature will make it harder/more expensive to produce 311° C. steam.

In some embodiments, the flow of HTWF through the evaporator 1110a is approximately twice what it would otherwise be to account for the flow recirculation. In some embodiments, 80% of the HTWF is recirculated and 20% proceeds to the preheater 1110b. In some embodiments, the 80% value shown in FIG. 11 can apply to Hitec® salts, and can be different for different salts (e.g., 50%-60% for a 60/40 salt. The salt exit temperature can also vary depending on the salt used—e.g., 150° C. for a Hitec® salt and 240° C. for a 60/40 salt.

In some embodiments, as described above, the system can use molten salts with lower melting points than those for 60/40 salts, such as Hitec® and Hitec XL® salts. Such salts are generally more expensive than higher temperature salts. However, the overall system cost may be achieved despite the increased salt cost. For example, because the lower melting point produces a larger ΔT (520° C.−170° C. or 150° C.), the overall mass/volume of salt storage for the same MWh capacity can be reduced. In addition to or in lieu of this result, the costs for preventing salt freeze can also be reduced. In some embodiments for which such a lower temperature molten salt is used, a stream of higher temperature molten salt (e.g., having the same composition) can be introduced at the entrance of the preheater to mix with the colder exhaust salt from the evaporator. This process can be accomplished with an injector or mixer, which can be configured to vary the flow rates of each stream depending on conditions.

The heat exchangers described above with reference to FIGS. 11-12B are in a counterflow or countercurrent arrangement, which is also shown in a representative system 1300 shown in FIG. 13. In FIG. 13, the hot HTWF from a storage tank 1312 splits into two flows. A first flow enters an attemperator 1111 and mixes with the colder HTWF that is recirculated from the exhaust of the evaporator 1110a. The ratio of the two flow rates depends on the temperatures of the two streams and the desired mixed temperature. Once the mixed HTWF has passed through the evaporator 1110a and decreased in temperature, it can be mixed with the second flow of hot HTWF before entering the preheater 1110b. This approach can reduce or eliminate the likelihood for the HTWF to freeze as it transfers heat to the incoming cold water inside the preheater 1110b.

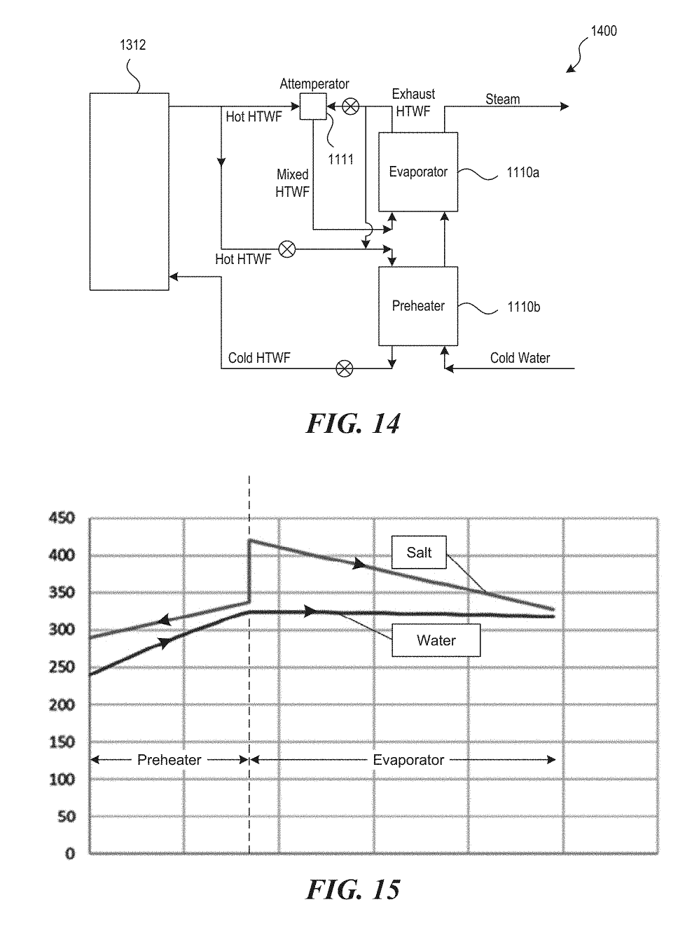

In some embodiments, the heat exchanger(s) can have a parallel flow or co-current arrangement, as shown in FIG. 14. In this example, the HTWF and water flow in parallel (and in the same direction) inside the evaporator 1110a. The co-current arrangement of the evaporator 1110a can further aid in reducing film boiling and scale formation, e.g., as a result of the reduced flux at any point in the heat exchanger, compared to a counterflow arrangement. In an example shown in FIG. 14, the preheater 111Ob can have a counterflow arrangement (e.g., to control cost by taking advantage of the higher flux associated with the counterflow arrangement), while the evaporator 1110a has a co-current arrangement. FIG. 15 illustrates corresponding temperature curves for the system 1400 shown in FIG. 14, with temperature (° C.) as a function of position in the heat exchanger. The water flows from left to right, and undergoes a temperature change from 240° C. to 311° C. The salt flow is a bit more complex. In the preheating section (to the left of the step change), the salt flows from right to left (i.e. countercurrent). In the evaporator section, however, the salt flows from left to right, i.e. the same direction as water. Once the salt exits the evaporator, it changes direction and goes into the preheater, which produces the discontinuity or step change in FIG. 15.

Systems configured in accordance with the examples described above with reference to FIGS. 11-15 (alone or in combination with any of the features described elsewhere herein) can produce one or more of several advantages, when compared with existing systems. Such advantages can include;
a. Higher temperatures (and therefore temperature differentials), which can improve overall thermal efficiency.
b. Corresponding reductions in the cost of thermal storage.
c. Reducing the temperature of HTWF prior to its entry into the steam generator can reduce the cost of the steam generator, and/or material compatibility issues which are typically associated with high temperature systems.
d. Segregating the water from the HTWF allows the use of water having very high total dissolved solids (TDS) in the steam generator which would otherwise not be permitted due to stress corrosion cracking issues experienced by high-grade austenitic steels.
e. Breaking up the overall heat exchange process into two processes (preheat and evaporation) can reduce or avoid pinch point concerns, and/or can allow the introduction of hot HTWF in the preheater section. The pinch point concern refers to a scenario in which the evaporator section removes too much heat from the salt, leaving little heat left for preheating. With separate preheat and evaporation sections, extra salt can be introduced at the break point between the sections to mitigate or eliminate this concern.
f. Introducing hot HTWF in the preheater section can reduce the likelihood for freezing the HTWF.
g. The arrangement can make the system less vulnerable to exergy deterioration in thermal storage. For example, the arrangement can allow the steam generator to run at lower temperatures than the temperature of the stored HTWF. Exergy deterioration refers generally to temperature degradation of the delivered heat when the heat storage device is nearly out of heat (e.g., the thermocline reaches the heat exit). This result is undesirable in power generation scenarios that use superheated steam. But with a steam generator designed to operate at lower temperatures (e.g., 425° C.), some reduction from the salt exit temperature of 520° C. is acceptable.
h. By varying the amount of attemperation, a large range of HTWF temperatures can be used for steam generation, thereby reducing the impact of exergy deterioration.
i. Lower temperature and not having to deal with quality controls helps reduce the cost of the preheater. For example, with no boiling in the preheater, the preheater can have a simpler design (e.g., shell and tube).

The foregoing features can have particular utility in systems or environments in which the available water quality is poor, for example, in the context of solar EOR and/or desalination processes. In a typical steam generator arrangement, the TDS and impurity levels of the water are tightly controlled because the power generating equipment requires very pure water. Controlling the water quality is not very expensive for power generation cycles because the water is constrained to flow a closed loop. Taking advantage of the low impurity levels of water, the typical evaporation process takes place in a circulation loop which produces very low-quality saturated steam at very high mass flow rates. A separator-vessel (e.g. a drum) then converts the low-quality steam into high-quality steam by circulating the excess condensate. Due to the low quality and high flow rates in the circulation loop, the problems of film boiling and scaling do not exist in a typical steam power generation system. Additionally, the power generating cycles require superheating and reheating water, which cools the HTWF before it enters the evaporator. As a result, the problem of a high-temperature difference at the evaporator also does not exist in the typical steam power generation system. However, such systems are not suitable for applications in which water purity is low and the temperature difference is high. Such applications occur, for example, in the context of solar EOR and water desalination. A particular desalination example (which can be applied to solar EOR in addition to or in, lieu of desalination) is described below.

One drawback associated with typical thermal EOR projects is that they produce much more water than oil. In many fields, the total liquids produced are approximately 95% water and only 5% oil in suspension which must be separated after extraction. The water left after separating out the oil often has a very high salinity and must be injected into permitted aquifers, or otherwise disposed of safely. In California alone, over 243,000 m³/day were injected for disposal in 2007, and the total value for the U.S. has been estimated to be about twelve times this amount. Many aquifers are filling up, and state agencies are reducing the number of new permits issued. Energy companies, therefore, have a growing problem: how to safely dispose of or reuse high salinity produced water.

In some embodiments of the presently disclosed technology, solar thermal desalination provides a solution to the foregoing problem. Produced water can be purified and reused for applications including, but not limited to, agriculture and municipal water supplies. The resulting concentrated brine stream is much smaller in volume and therefore easier and cheaper to dispose of. Accordingly, the technology can reduce the cost of solar collectors and associated equipment, and/or reduce the cost of thermal energy storage, as described further below.

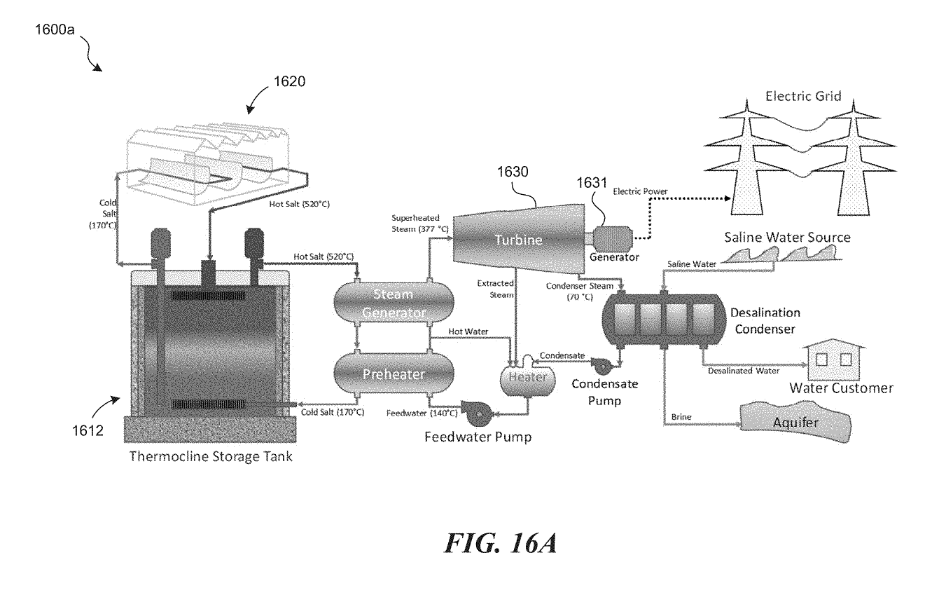

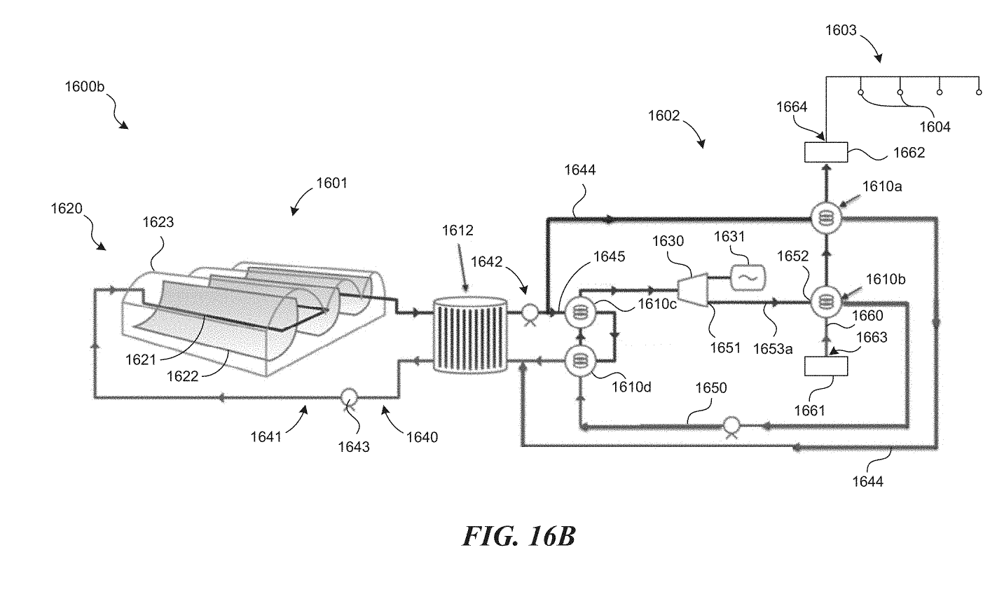

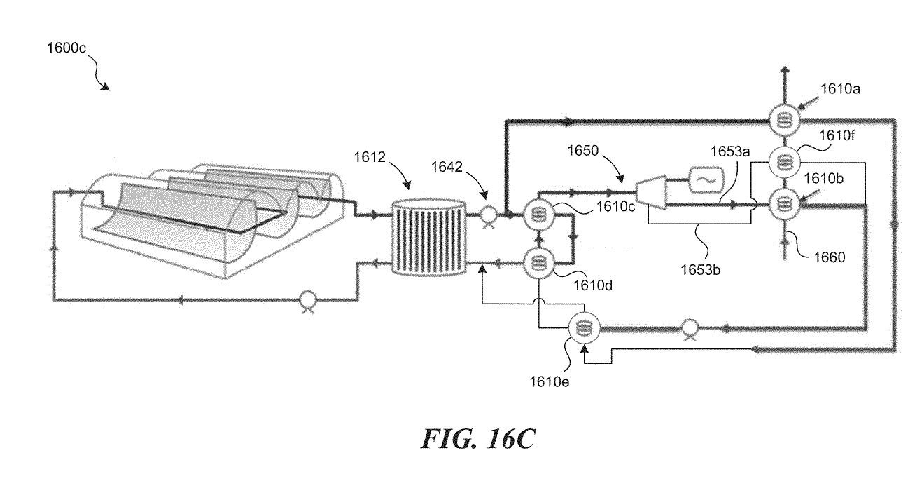

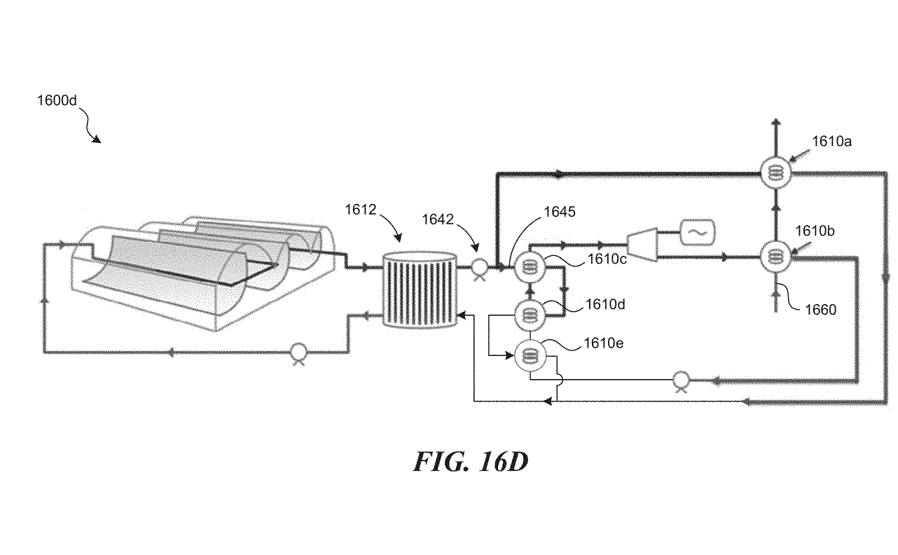

Oilfield operators typically have high electrical and thermal energy loads. A dual-use plant in accordance with the present technology can produce both power and water at lower cost than either alone. FIG. 16A illustrates a schematic of a plant or system 1600a configured to collect solar energy at a solar field 1620, and use the energy to drive a turbine 1630 and generator 1631 to produce electricity. Waste heat from the turbine is then used to desalinate water for use in homes and/or industries. The water can be obtained from a naturally-occurring saline water source, and/or can be a by-product of a solar EOR operation. In other variants, the turbine 1630 can be eliminated and the system 1600a can be dedicated to desalination, solar EOR, and/or other applications. In still further embodiments, the generated heat can be used for other purposes. In some embodiments, the system 1600a includes one or more multi-effect distillation (MED) devices. Such devices can operate with low quality heat (e.g., 70° C.) and can therefore entirely replace the condenser at the back end of a steam turbine 1630. Multistage flash (MSF) systems can also be used, but may require somewhat higher temperature steam extraction to operate (3.5 bar at 135° C.) and so may not entirely replace the condenser. Thermal vapor compression (TVC) can be used for small standalone installations, or can be coupled with MSF or MED.

In a representative example, the solar field 1620 can be or can include an enclosed trough solar collector system covering ¼ square mile of land. Representative enclosed systems are described in issued U.S. Pat. No. 8,915,244 and co-pending US Patent Publication No. US 2018/0209162, each of which is incorporated herein by reference. A representative plant produces 20 MW of electrical power and 22,000 m³ per day of fresh water, in addition to reducing produced water volumes (e.g., by 60%) and/or generating carbon reduction credits. Low cost thermal storage is used to increase/maximize the utilization of the steam turbine 1630 and desalination equipment. In a representative example, a thermal storage device 1612 stores heat in a molten salt at 538° C. and first generates electricity with this high exergy energy storage using the steam turbine 1630. The steam turbine waste heat is then used to drive a desalination process.

FIGS. 16B-16D illustrate systems having several features similar to those described above with reference FIGS. 11-16A, in accordance with further embodiments of the present technology. A representative system 1600b shown in FIG. 16B includes several high-level features similar to those described above with reference to the foregoing figures, including a heat collection system 1601 (which collects solar energy), a thermal storage device 1612 (which stores the energy collected by the heat collection system 1601), and a heat conversion system 1602 that converts the collected and stored heat to another energy form, used by an application 1603. In some embodiments, the application 1603 can include oilfield injection wells 1604, and in others, the application 1603 can include other process heat functions.

The heat collection system 1601 can include a solar field 1620, that in turn includes an enclosure 1623 housing one or more receivers 1621. The receivers 1621 receive concentrated solar energy from one or more corresponding concentrators 1622. The receivers 1621 can be suspended from the enclosure 1623, and the concentrators 1622 can be suspended from the corresponding receivers 1621. An HTWF loop 1640 transfers heat collected at the solar field 1620 to the thermal storage device 1612, and directs the heat to the heat conversion system 1602. Accordingly, the HTWF loop 1640 can include a heat input portion 1641 and a heat output portion 1642. Valves 1643 (some of which are illustrated) regulate the flows throughout the system 1600b.

The heat output portion 1642 of the HTWF loop 1640 can include multiple branches, illustrated in FIG. 16B as a first branch 1644 and a second, parallel branch 1645. Each branch receives hot HTWF, transfers heat to be used by the application 1603, and returns cooled HTWF back to the thermal storage device 1612. The first branch 1644 transfers heat from the HTWF to a process fluid (carried via a process fluid flow path 1660), at a first heat exchanger 1610a. The second branch 1645 transfers heat to the process fluid at second heat exchanger 1610b. The second branch 1645 delivers heat to the process fluid at a lower temperature than does the first branch 1644 and the first heat exchanger 1610a. Accordingly, the first heat exchanger 1610a can be or can include an evaporator, and the second heat of exchanger 1610b can be or can include a preheater. The process fluid flow path 1660 includes a process fluid input 1661 (e.g., a source of water) and a process fluid output 1662 (e.g., a steam delivery point). Because the process fluid may include primarily water, but with a high level of contaminants, the process fluid flow path 1660 can be configured as a once-through or non-recirculating flow path. In particular configurations, the process fluid flow path 1660 can include a pig entry point 1663 and a corresponding pig exit point 1664 to allow the process fluid flow path 1660 to be cleaned, as needed, via a pigging operation. The portion of the process fluid flow path 1660 between the pig entry point 1663 and exit point 1664 can be devoid of sharp curves and/or other elements that may inhibit the passage of the cleaning pigs.

The second branch 1645 of the heat output portion 1642 extracts heat from the HTWF before delivering additional heat, at a lower temperature, to the process fluid via the second heat exchanger 1610b. For example, the second branch 1645 can include a third heat exchanger 1610c that delivers heat to a low temperature working fluid (LTWF) carried by an LTWF loop 1650. The LTWF can include water or another suitable lower temperature working fluid. Unlike the water that may be used in the process fluid flow path 1660, water in the LTWF loop 1650 is sufficiently pure to be recirculated and, in at least some embodiments, is used to drive turbomachinery. For example, the LTWF can be provided to a turbine 1630 that drives a generator 1631 to produce power that can in turn be used by the application 1603, or can be delivered to the grid, or other suitable users. A first portion 1653a of the LTWF loop 1650 directs exhaust water and/or steam from the outlet 1651 of the turbine 1630 to an inlet 1652 of the second heat exchanger 1610b. At the second heat exchanger 1610b, the LTWF preheats the process fluid, and then returns to the third heat exchanger 1610c to be reheated by the HTWF. Optionally, the system 1600b can include a fourth heat exchanger 1610d that preheats the LTWF and extracts additional energy from the second branch 1645 of the heat output portion 1642.

FIGS. 16C and 16D illustrate further variants of the overall system described above. For example, FIG. 16C illustrates a system 1600c having an arrangement generally similarly to that of the system 1600b described above, with additional heat exchangers, shown as a fifth heat exchanger 1610e and a sixth heat exchanger 1610f. The sixth heat exchanger 1610f delivers heat to the process fluid in the process fluid flow path 1660 at a temperature lower than that at the first heat exchanger 1610a, and higher than that at the second heat exchanger 1610b. Accordingly, LTWF loop 1050 can include a second portion 1653b (in addition to the first portion 1653a) that extracts heat from a higher pressure, higher temperature stage of the turbine 1630. In other embodiments, the system can include additional heat exchangers and corresponding portions of the LTWF loop 1650 that remove heat at selected temperatures and pressures from the turbine 1630.

The fifth heat exchanger 1610e operates to further preheat the LTWF via HTWF from the first branch 1644 of the heat output portion 1642. The LTWF proceeds from the fifth heat exchanger 1610e to the fourth heat exchanger 1610d and then to the third heat exchanger 1610c. The HTWF proceeds from the fifth heat exchanger 1610e to the thermal storage device 1612.

FIG. 16D illustrates a system 1600d that also includes a fifth heat exchanger 1610e having a slightly different arrangement than was described above with reference to FIG. 160. In particular, the fifth heat exchanger 1610e shown in FIG. 16D preheats the incoming LTWF via HTWF obtained from the second branch 1645 (rather than the first branch 1644) of the heat output portion 1642.

The foregoing configurations described above with reference to FIGS. 16A-16D may be combined and/or modified to produce configurations other than those specifically shown in the Figures. For example, the arrangement shown in FIG. 16C in which low temperature working fluid is extracted from the steam turbine 1630 at multiple locations, can be combined with the arrangement shown in FIG. 16D in which the low temperature working fluid is preheated via HTWF obtained via the second branch 1645. In another representative example, the configuration can include one or more attemperators, e.g., as described with reference to FIG. 11. Further representative systems can include a gas-fired backup capability and/or a temperature top-up capability to top up the HTWF and/or LTWF temperatures. For example, a gas-fired heater can be positioned in the HTWF loop 1640, upstream of the location at which the first and second branches 1644, 1645 split, to top-up the temperature of the HTWF. The same or a different heater can preheat the LWTF, e.g., at the fifth heat exchanger 1610e, or a gas-fired steam superheater can be included in the LTWF loop 1050, e.g., between the third heat exchanger 1610c and the turbine 1630. A portion of the heated process fluid can be used to preheat incoming process fluid. The solar field can directly heat the HTWF, or it can heat the HTWF indirectly. For example, the solar field can heat a recirculating oil, which in turn heats the HTWF at a corresponding heat exchanger. In this case, the HTWF loop 1640 still thermally couples the thermal storage device to the solar field, via the intermediate recirculating oil and heat exchanger.

One feature of several of the systems described above is that the lower temperature LTWF (e.g., water) preheats the process fluid before the higher temperature HTWF adds further heat. An advantage of this arrangement is that it reduces or eliminates the likelihood for the HTWF to freeze when transferring heat to the process fluid.

### 4.0 Further Representative Heat Storage Devices

As discussed above, one representative application for collected solar energy is desalination, e.g., multi-effect distillation (MED). While MED units may be implemented in some embodiments, such units typically include very large vacuum chambers that take hours to depressurize and reach operation temperature and therefore cannot economically be cycled every day. Furthermore, due to their high capital cost, MED units must be utilized as much of the year as possible so as to amortize costs over a larger amount of output. Accordingly, thermal energy storage units of the types described herein can smooth out the flow of energy collected at the solar field, whether used for desalination and/or other applications.

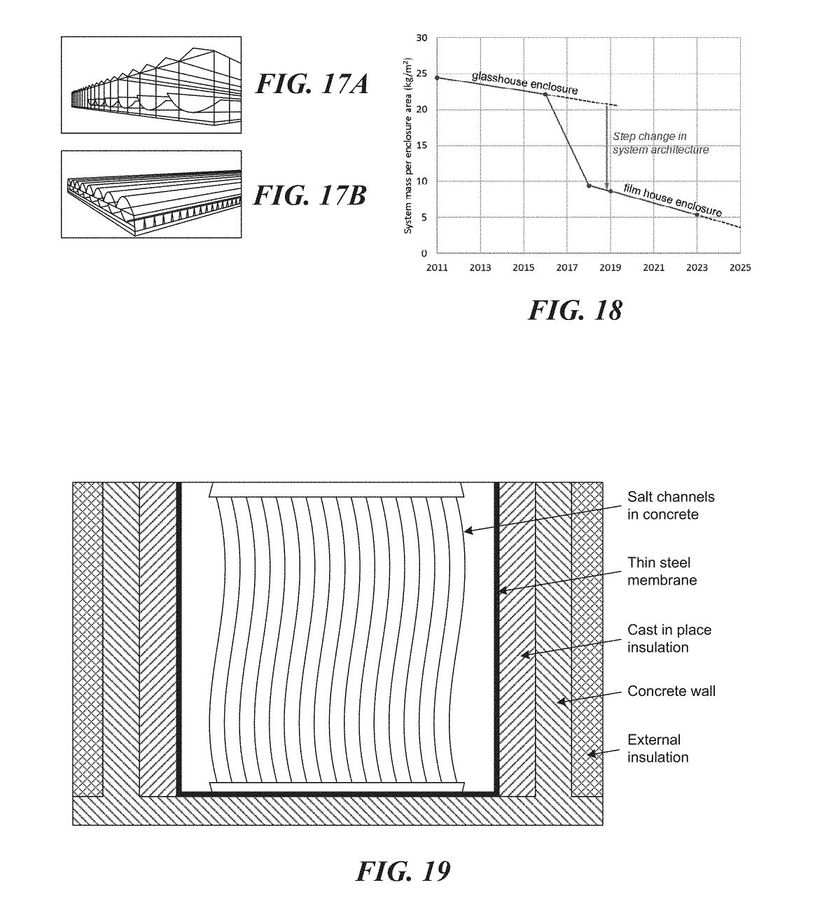

GlassPoint Solar, Inc., the assignee of the present application, has developed multiple types of transparent enclosures, enabling the use of super lightweight structures in a zero-wind environment. Such structures include can glass-enclosed structures (shown in FIG. 17A and described further in U.S. Pat. No. 8,915,244, previously incorporated herein by reference) and/or thin-film enclosed structures (shown in FIG. 17B and described further in U.S. Patent Publication No. US 2018/0209162, previously incorporated herein by reference). FIG. 18 illustrates the total expected mass per unit footprint of the enclosure (as a function of development time), for each of the foregoing designs. By 2023, the expected mass per unit footprint of the enclosure can be reduced to 7 kg/m², or, as shown in FIG. 18, 5 kg/m². By contrast, a traditional non-enclosed parabolic trough collector typically requires ˜30 kg/m² on an aperture basis.

The costs for thermal energy storage (TES) units are strongly dependent on the salt volume required to store the thermal energy. This volume can be reduced or minimized by increasing the temperature difference (ΔT) between the hot salt and the cold salt operating temperatures. In some embodiments, the HTWF is selected to be or to include a low melting point nitrate/nitrite salt (e.g., Hitec® with a melting point at 142° C.). Other low melting point salts may also be suitable. For example a eutectic mixture with lithium nitrate, e.g., LiNO₃, NaNO₃ and KNO₃ (120° C. melting point) can produce an even larger ΔT. In another example, the salt can include a mixture of NaNO₃, KNO₃, and Ca(NO₃)₂, which also has a melting point near 120° C. The low void fraction described above with reference to representative concrete storage units can reduce or minimize the amount of salt needed for storage, which allows use of higher performance salts (having higher costs per ton) while preserving the economic viability of the overall system.

Conventional Rankine cycle designs preheat the feedwater to a temperature sufficient to avoid freezing a 60/40 solar salt. By contrast, examples of the presently disclosed technology can reduce the temperature of the feedwater to enable a larger temperature difference between the feedwater and the stored HTWF. The technology can further include a steam generator that tolerates feedwater temperatures below the melting point of the molten salt (or other HTWF), enabling much lower cold salt temperatures and lower overall system costs, without freezing the salt. For example, the system can recirculate hot water from the preheater exit to mix with incoming cold feedwater before it approaches the salt-wetted tubing, as shown in FIG. 16. This approach can reduce or eliminate the risk of cold water on one side of a heat exchanger tube and (hot) salt on the other.

Put another way, some embodiments of the present technology use HTWF and cold water to produce a high overall efficiency, while internally controlling the heat transfer between these fluids to reduce or eliminate film boiling, scale formation, and/or freezing the HTWF.

The storage units described above can significantly reduce void fractions. For example, by forming cast-in-place concrete material in the manners described above, the void fractions can be reduced to 5©, Because aggregate and concrete materials cost in the range of $50-$100 per ton, and molten salt costs in the range of $1000-$2000 per ton, reducing the volume occupied by the molten salt (e.g., to 5%) can significantly reduce overall system cost.

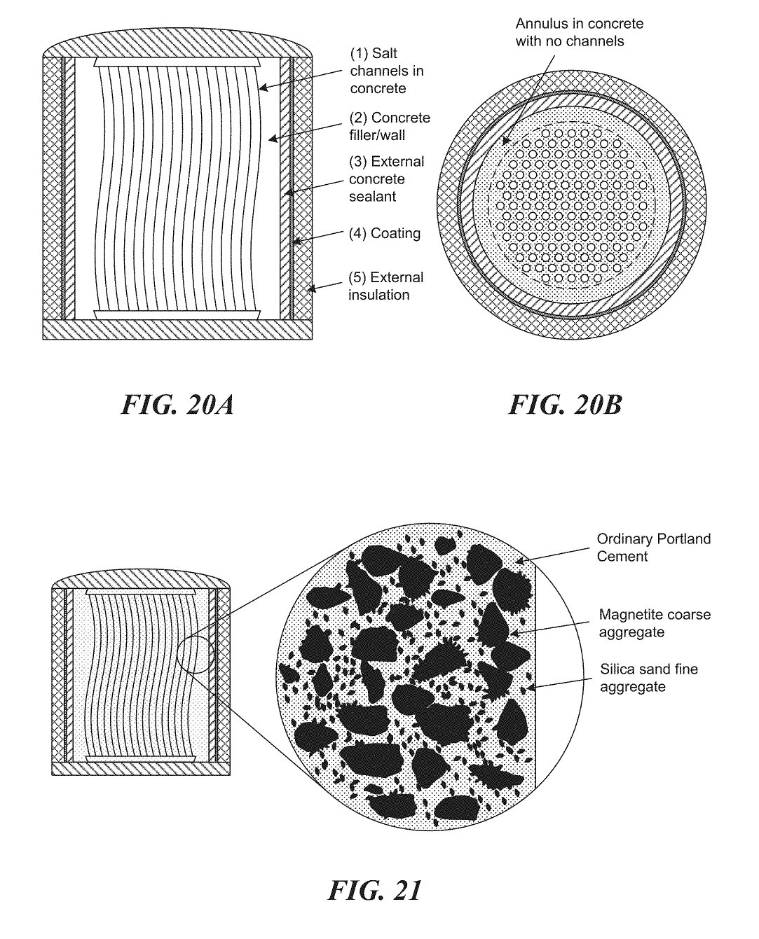

After the salt, the steel tank is typically the most expensive component of a TES system. In some embodiments, the tank can be formed using slip-form concrete silo construction techniques. The concrete tank can be lined with a thin steel bladder that is in direct contact with the salt (or other HTWF) and filler. The thin layer (e.g., formed from carbon steel) can be significantly less expensive that the stainless steel used in a typical conventional TES tank. A layer of internal insulation can be poured or otherwise disposed around the bladder to protect the concrete from the high internal temperature. An additional layer of external insulation can be installed outside the concrete to reduce heat losses and bring the surface temperature down to a touch-safe level. FIGS. 19 and 20A, 20B illustrates representative tank constructions. In particular embodiments, the overall system can include one or more low-cost concrete storage tanks that utilize the inherent strength of the self-supporting monolithic concrete filler to eliminate the need for a steel wall or reinforcing rebar. A layer of spray-on concrete treated with a salt sealant can be applied to the outside surface of the concrete filler.

A conventional thermocline tank, with an aggregate filler material in the interior volume of the tank, is subject to high stresses and damage as the rocks settle into the lower positions inside the tank, resisting tank contraction upon cooling in a process called thermal ratcheting. This problem is mitigated or eliminated by using a self-supporting filler material in the form of an engineered concrete with interleaved salt channels, as described above and shown in FIGS. 19 and 20A, 20B. This solid concrete will not settle during thermal cycling, and no fillers are used. The channels can be formed via single or multi-strand polypropylene strings, e.g., having a diameter in a range of from 1 mm to 20 mm in some embodiments, and approximately 2-3 mm in some embodiments. The strings can be held in place during concrete pouring and remain in place as the concrete sets. Upon system startup, the concrete will be heated and the strings will melt away, leaving salt channels of the desired diameter and packing density. The diameter, spacing and stiffness of the strings can be selected to produce the desired channel shape and size. For example, stiffer strings can be used to form the undulating channels shown in FIGS. 19 and 20A, 20B.

The concrete can include magnetite rock (e.g., in the form of taconite pellets) as the coarse aggregate mixed with silica sand as the fine aggregate. Magnetite has a high density and low cost and has been shown to be compatible with molten salt. Other suitable coarse aggregates can include quartzite and/or olivine. A chemical admixture can be used to increase the viscosity of the wet concrete and lower the required amount of water, increasing the ultimate strength of the set concrete. FIG. 21 shows a representative schematic of the high-density concrete. The cement serves as a self-supporting filler material, in which the aggregate is solidly embedded, to reduce/eliminate ratcheting.

In some embodiments, the exterior of the concrete filler is coated with a spray-on layer of concrete that incorporates an external coating and an additive that swells upon exposure to molten salt, enabling a leak-tight, self-healing skin. The concrete itself is porous and will allow some salt wicking, although the permeability of concrete can be reduced to acceptable levels. A coating of boron nitride or a similar material can reduce salt permeation through refractory cements. Other representative coatings may include alumina, aluminophosphates, zirconia, and/or silicates. Any of the foregoing coatings can be sprayed on, brushed on, rolled on, or otherwise applied.

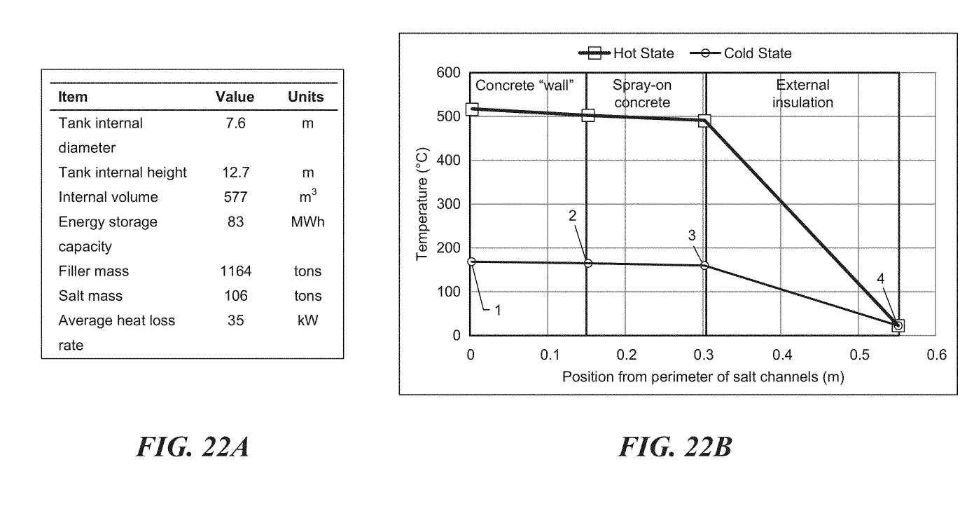

A representative modular storage tank has a capacity of 83 MWh. Representative tank dimensions are shown in FIG. 22A. At this size it is feasible to achieve an approximately 1% heat loss rate per day with reasonable insulation thickness. This thermal performance matches the typical heat losses of much larger conventional molten salt storage tanks. Approximately 70% of the heat is lost through the walls, and FIG. 22B shows a representative temperature drop through each part of the wall.

Another problem associated with conventional thermocline storage tanks is that the temperature of the hot salt discharged from the tank tends to “droop” toward the end of the cycle as the thermocline zone approaches the salt outlet. This phenomenon limits the practical use of thermoclines for power generation applications that are sensitive to steam temperature and pressure. Accordingly, existing projects with thermocline storage achieved 69% utilization of the potential storage volume before the temperature droop became too large. The low void fraction filler described above is expected to reduce convective mixing and the height of the thermocline zone and thereby reduce or minimize the resulting temperature droop during discharge. In addition to or in lieu of this arrangement, the system can include a droop-tolerant steam Rankine power block and utilize a series arrangement of thermocline tanks and early morning hours to boost intermediate salt temperatures, (e.g., multiple storage units coupled with a solar system to utilize lukewarm storage and direct solar heated salt in the morning to start the day's solar energy generation).

More generally, steam turbines are typically designed for a given operating temperature and exhibit reduced efficiency when operating at colder temperatures. Systems in accordance with embodiments of the present technology can utilize a somewhat lower design point temperature for the steam turbine (e.g., 420° C.), which has some penalty in gross conversion efficiency but allows more temperature drop in the molten salt provided to the steam generator during discharge. Allowing more temperature drop means more of the storage tank volume can be utilized during each discharge cycle, reducing total system costs. Accordingly, a representative Rankine system can tolerate a 20° C. temperature drop of the molten salt during the discharge cycle (from a nominal 530° C. to 510° C.), and can result in an estimated 80% utilization factor for the thermocline system.

In some embodiments, as described above, the system can include multiple modular concrete tanks, significantly reducing the cost of the thermal storage system. The tanks can be built in a modular “step and repeat” fashion to take advantage of economies of scale in number of units, not in size. This approach can eliminate the single point of failure risk associated with a large single tank and can also allow modular solar fields to be deployed more rapidly. The tanks can be taller than they are wide (an aspect ratio diameter/height less than one). The thermocline zone tends to be a constant height regardless of tank diameter, which can make tall skinny tanks preferable to short wide ones. This in turn can reduce the effect of temperature droop on discharge, because more of the tank volume will experience the full temperature swing from hot to cold during discharge. A smaller diameter tank has the additional benefit of reducing the absolute amount of thermal expansion and contraction during thermal cycles. This reduces thermal stresses and allows a more robust design. A system with many distributed modular tanks will require more piping to bring the heat to the centrally-located power block versus a design with a single large tank near the power block. However, this is expected to be a small penalty (and can be mitigated via insulation and/or other techniques, so as to enable very large projects without excessive piping losses

In a particular embodiment, the systems described above can include trough-shaped, mirror-based solar concentrators. In other embodiments, the solar collection systems can include other types of solar collectors, including, but not limited to point-source collectors, power-tower arrangements, dish-shaped collectors, and/or Fresnel collectors. Particular embodiments of the systems described above were described in the context of water as a working fluid. In other embodiments, the systems can operate in generally the same manner, using other types of working fluids, or combinations of different working fluids. In some embodiments, the concrete filler-based tank can be replaced with a self-supporting refractory brick configuration, e.g., a silica/alumina refractory brick, or a brick that includes sintered magnetite. In some embodiments, a thin steel cladding (e.g., 3-6 mm thick) can be added to the exterior of the concrete portion of the tank to prevent salt leakage.

While various advantages and features associated with certain embodiments have been described above in the context of those embodiments, other embodiments may also exhibit such advantages and/or features, and not all embodiments need necessarily exhibit such advantages and/or features to fall within the scope of the present technology. Accordingly, the disclosure can encompass other embodiments not expressly shown or described herein.

To the extent any materials incorporated herein by reference conflict with the present disclosure, the present disclosure controls.

I/We claim:

1. A solar-powered steam generation system, comprising:
a solar field that includes:
a receiver; and
a concentrator positioned to direct concentrated solar energy to the receiver;
a thermal storage device;
a heat conversion system; and
a high temperature working fluid loop having a heat input portion coupled between the thermal storage device and the solar field, and a heat output portion coupled between the thermal storage device and the heat conversion system, the heat output portion including:
a first branch coupled to a first heat exchanger to transfer heat to a process fluid at a first temperature; and
a second branch coupled to a second heat exchanger in parallel with the first branch to transfer heat to the process fluid at a second temperature lower than the first temperature.

2. The steam generation system of claim 1 wherein:
the solar field further includes an enclosure;
the receiver is one of a plurality of receivers suspended from and within the enclosure; and
the concentrator is one of a plurality of concentrators suspended from corresponding receivers.

3. The steam generation system of claim 1, further comprising a high temperature working fluid in the high temperature working fluid loop, and wherein the high temperature working fluid includes a molten salt.

4. The steam generation system of claim 1, further comprising the process fluid, and wherein the process fluid is primarily water.

5. The steam generation system of claim 1, further comprising a fluid flow path coupled between a process fluid outlet of the first heat exchanger and an enhanced oil recovery injection well.

6. The steam generation system of claim 1, further comprising an attemperator coupled between the thermal storage device and the first heat exchanger, in the first branch.

7. The steam generation system of claim 1, further comprising:
a third heat exchanger positioned in the second branch; and
a low temperature working fluid loop coupled between the second heat exchanger and the third heat exchanger.

8. The steam generation system of claim 7, further comprising:
a fourth heat exchanger positioned in the second branch of the high temperature working fluid loop downstream of the third heat exchanger to preheat a low temperature working fluid in the low temperature working fluid loop upstream of the third heat exchanger.

9. The steam generator system of claim 7, further comprising:
a fifth heat exchanger positioned in the low temperature working fluid loop, the fifth heat exchanger being coupled to the first branch of the high temperature working fluid loop to transfer heat from the first branch to the low temperature working fluid loop.

10. The steam generation system of claim 7, further comprising:
a steam turbine coupled in the low temperature working fluid loop between the second heat exchanger and the third heat exchanger; and
a generator coupled to the steam turbine to generate electrical power; and wherein
a portion of the low temperature working fluid loop is coupled between an outlet of the steam turbine and an inlet of the second heat exchanger to transfer heat from a low temperature working fluid in the low temperature working fluid loop to the process fluid, at the second temperature.

11. The steam generation system of claim 1, further comprising a fluid flow path for the process fluid, the fluid flow path having a once-through, non-recirculating configuration.

12. The steam generation system of claim 11 wherein the fluid flow path includes a cleaning pig entry port and a cleaning pig exit port.

13. The steam generation system of claim 12 wherein the fluid flow path includes no pig-inhibiting bends between the cleaning pig entry port and the cleaning pig exit port.

14. The steam generation system of claim 1, wherein the thermal storage device includes concrete having flow channels.

15. The steam generation system of claim 14, wherein the concrete includes a magnetite aggregate.

16. The steam generation system of claim 14 wherein the flow channels are generally circular and have a diameter in a range from 1 millimeter to 20 millimeters.

17. The steam generation system of claim 14 wherein the thermal storage device includes a steel membrane around the concrete.

18. A solar-powered steam generation system, comprising:
a solar field;
a thermal storage device;
a heat conversion system; and
a high temperature working fluid loop carrying a molten salt and having a heat input portion coupled between the heat storage unit and the solar field, and a heat output portion being coupled between the heat storage unit and the heat conversion system, the heat output portion including:
a first branch coupled between the heat storage unit and a first heat exchanger to transfer heat to a process fluid at a first temperature, the process fluid including water;
a second branch coupled between the heat storage unit and a second heat exchanger, the second branch further including a third heat exchanger;
a low temperature working fluid loop carrying water and coupled between the second heat exchanger and the third heat exchanger;
a steam turbine coupled in the low temperature working fluid loop between the second heat exchanger and the third heat exchanger; and
a generator coupled to the steam turbine to generate electrical power; and wherein
a portion of the low temperature working fluid loop is coupled between an outlet of the steam turbine and an inlet of the second heat exchanger to transfer heat from water in the low temperature working fluid loop to the process fluid, at a second temperature lower than the first temperature.

19. The steam generation system of claim 18, further comprising a fourth heat exchanger positioned in the second branch of the high temperature working fluid loop, downstream of the third heat exchanger, to preheat the low temperature working fluid in the low temperature working fluid loop upstream of the third heat exchanger.

20. The steam generation system of claim 18, further comprising a fifth heat exchanger coupled between the high temperature working fluid loop and the low temperature working fluid loop to heat the low temperature working fluid upstream of the third heat exchanger.

21. The steam generation system of claim 18 wherein:
the portion of the low temperature working fluid loop is a first portion; and
the outlet of the steam turbine is a first outlet; and wherein the system further comprises:
an additional heat exchanger; and
a second portion of the low temperature working fluid loop coupled between a second outlet of the steam turbine and the additional heat exchanger to transfer heat from water in the low temperature working fluid loop to the process fluid, at a third temperature lower than the first temperature and higher than the second temperature.

22. The steam generation system of claim 18, wherein the solar field includes:
an enclosure transmissive to incident solar radiation;
a plurality of receiver conduits suspended from, and positioned within, the enclosure; and
a plurality of concentrators positioned to direct concentrated solar energy to corresponding receiver conduits.

23. A controller programmed with instructions that, when executed:
direct a high temperature working fluid (a) from a thermal storage device to a solar field to heat the high temperature working fluid, and (b) back to the thermal storage device;
direct a first portion of the high temperature working fluid from the thermal storage device through a first branch of a high temperature working fluid loop to a first heat exchanger to transfer heat to a process fluid at a first temperature; and
direct a second portion of the high temperature working fluid from the thermal storage device through a second branch of the high temperature working fluid loop, in parallel with the first branch, to transfer heat to the process fluid at a second temperature less than the first temperature via a second heat exchanger.

24. The controller of claim 23 wherein the instructions, when executed direct the process fluid to an enhanced oil recovery injection well.

25. The controller of claim 23 wherein the instructions, when executed direct the second portion of the high temperature working fluid to a third heat exchanger to transfer heat to a low temperature working fluid, and wherein the low temperature working fluid transfers heat to the process fluid at the second temperature.

26. The controller of claim 25 wherein the instructions, when executed direct the second portion of the high temperature working fluid to a fourth heat exchanger in the second branch, downstream of the third heat exchanger, to preheat the low temperature working fluid in the low temperature working fluid loop upstream of the third heat exchanger.

27. The controller of claim 25 wherein the instructions, when executed direct the first portion of the high temperature working fluid through a fifth heat exchanger to heat the low temperature working fluid upstream of the third heat exchanger.

28. The controller of claim 25 wherein the instructions, when executed:
direct the low temperature heat transfer fluid through a steam turbine to generate electrical power; and
direct the low temperature working fluid from the steam turbine to the second heat exchanger to heat the process fluid at the second temperature.

29. The controller of claim 23 wherein the instructions, when executed, direct the process fluid in a once-through, non-recirculating manner.

30. A method for controlling a solar-powered steam generation system, comprising:
directing a high temperature working fluid (a) from a thermal storage device to a solar field to heat the high temperature working fluid, and (b) back to the thermal storage device;
directing a first portion of the high temperature working fluid from the thermal storage device through a first branch of a high temperature working fluid loop to transfer heat to a process fluid at a first temperature; and
directing a second portion of the high temperature working fluid from the thermal storage device through a second branch of the high temperature working fluid loop, in parallel with the first branch, to transfer heat to the process fluid at a second temperature less than the first temperature.

31. The method of claim 30, further comprising directing the process fluid to an enhanced oil recovery injection well.

32. The method of claim 30, further comprising directing the second portion of the high temperature working fluid to a third heat exchanger to transfer heat to a low temperature working fluid, and wherein the low temperature working fluid transfers heat to the process fluid at the second temperature.

33. The method of claim 32 further comprising directing the second portion of the high temperature working fluid to a fourth heat exchanger in the second branch, downstream of the third heat exchanger, to preheat the low temperature working fluid in the low temperature working fluid loop upstream of the third heat exchanger.

34. The method of claim 32 further comprising directing the first portion of the high temperature working fluid through a fifth heat exchanger to heat the low temperature working fluid upstream of the third heat exchanger.

35. The method of claim 32 further comprising:
directing the low temperature heat transfer fluid through a steam turbine to generate electrical power; and
directing the low temperature working fluid from the steam turbine to the second heat exchanger to heat the process fluid at the second temperature.

36. The method of claim 30, further comprising directing the process fluid in a once-through, non-recirculating manner.
